(19) United States
(12) Patent Application Publication
(10) Pub. No.: US 2026/0211859 A1
(43) Pub. Date: Jul. 23, 2026

(54) SYSTEM AND METHOD FOR METADATA-DRIVEN DATA QUALITY PROCESSING FOR IN-FLIGHT DATA QUALITY ASSESSMENT

(71) Applicant: Genworth Holdings, Inc., Richmond, VA (US)

(72) Inventors: Christopher Corrigan, Chesterfield, VA (US); Atul Saurav, Glen Allen, VA (US); Bibi Zainab Shaikh, Maharashtra (IN)

(21) Appl. No.: 19/571,715

(22) Filed: Mar. 19, 2026

Related U.S. Application Data
(63) Continuation-in-part of application No. 18/742,058, filed on Jun. 13, 2024, now Pat. No. 12,585,625.
Application No. 18/742,058 is a continuation of application No. 17/941,266, filed on Sep. 9, 2022, now Pat. No. 12,050,568.

(51) Int. Cl. G06F 16/215; G06F 16/23

(52) U.S. Cl. CPC G06F 16/215; G06F 16/2365

(57) ABSTRACT

An embodiment of the present invention is directed to data quality processing of data in-flight within a data pipeline that includes reading source data from one or more input datasets into a dataframe. The system reads source data from an input dataset into a dataframe within a data pipeline and applies data quality rules to the dataframe while the source data is in-flight within the data pipeline. The system determines a pipeline action based on metadata associated with the one or more data quality rules. The pipeline action may be selected from a group of a drop action that discards failed records, a quarantine action that stores failed records in a separate table, a warn action that loads all records with quality flags, and a fail action that prevents data loading and sets the pipeline to a failed status.

### CROSS REFERENCE TO RELATED APPLICATIONS

This application is a Continuation-In-Part of U.S. Application No. 18/742,058, titled “System and Method for Implementing a Data Quality Framework and Engine,” filed Jun. 13, 2024, which is a Continuation of U.S. Application No. 17/941,266, now U.S. Patent No. 12,050,568, titled “System and Method for Implementing a Data Quality Framework and Engine,” filed Sep. 9, 2022, which are hereby incorporated by reference in their entirety.

### FIELD OF THE INVENTION

The present disclosure relates to data quality management systems for data processing pipelines, and more particularly to metadata-driven data quality checks applied to data in-flight during pipeline execution and on-demand data quality assessment for data at rest.

### BACKGROUND OF THE INVENTION

Data processing systems frequently involve the movement of data from source systems to target systems through data pipelines. These pipelines may read data from one or more source datasets, apply various transformations, and write the processed data to target destinations. During this data movement process, the quality of the data being transferred can affect downstream systems, analytics, and business intelligence applications that consume the processed data.

Traditional approaches to data quality assessment have focused on evaluating data after it has been loaded into a target system or database. In such approaches, data quality checks are performed on data at rest, meaning the data has completed its movement through the pipeline and resides in a storage location. While this approach can identify data quality issues, the issues are detected after the data has already propagated through the system and potentially affected downstream processes.

Data pipelines in modern computing environments often process large volumes of data across multiple layers or stages. For example, data may move from a raw data layer to a standardized layer, then to a curated layer, and finally to a tailored layer for specific analytical purposes. Each layer may have different quality expectations and standards. Maintaining data quality across these multiple layers presents challenges, particularly when different use cases have varying tolerance levels for data quality issues.

When data quality issues are detected after data has been loaded to a target system, remediation efforts can be costly and time-consuming. Bad data that has propagated through a system may have already been used in reports, analytics, or decision-making processes. Identifying and correcting such issues retroactively requires additional resources and may necessitate reprocessing of data and regeneration of affected outputs.

Accordingly, there is a need for improved approaches to data quality management that address data quality during various stages of data processing.

### SUMMARY OF THE INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for data quality assessment in a data pipeline is provided. The system comprises: an input configured to interface with one or more data sources through an extract, transform and load (ETL) pipeline; and a computer processor coupled to the input and configured to perform the steps of: reading source data from one or more input datasets into a dataframe within a data pipeline; retrieving, from a rules repository, one or more data quality rules applicable to the dataframe based on metadata associated with the data pipeline; applying the one or more data quality rules to the dataframe while the source data is in-flight within the data pipeline; determining whether one or more records within the dataframe fail at least one of the one or more data quality rules as failed records; determining a pipeline action based on metadata associated with the one or more data quality rules; executing the pipeline action on the failed records, wherein the pipeline action is selected from one of: a drop action, a quarantine action, a warn action, and a fail action; and applying one or more transformations to passed records that pass the one or more data quality rules to produce transformed records.

According to an aspect of the present disclosure, a method for data quality assessment in a data pipeline is provided. The method comprises the steps of: reading source data from one or more input datasets into a dataframe within a data pipeline; retrieving, from a rules repository, one or more data quality rules applicable to the dataframe based on metadata associated with the data pipeline; applying the one or more data quality rules to the dataframe while the source data is in-flight within the data pipeline; determining whether one or more records within the dataframe fail at least one of the one or more data quality rules as failed records; determining a pipeline action based on metadata associated with the one or more data quality rules; executing the pipeline action on the failed records, wherein the pipeline action is selected from one of: a drop action, a quarantine action, a warn action, and a fail action; and applying one or more transformations to passed records that pass the one or more data quality rules to produce transformed records.

Users of data platforms may have different requirements for data quality depending on their specific use cases. For instance, data used for executive dashboards may require higher quality standards than data used for exploratory analysis. An embodiment of the present invention enables users to assess data quality on demand, according to their specific requirements and thresholds, thereby realizing flexible and targeted quality management.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flowchart of an overall architecture, according to an embodiment of the present invention.

FIG. 2 is an exemplary flowchart of an overall process, according to an embodiment of the present invention.

FIG. 3 illustrates metadata types and relationships, according to an embodiment of the present invention.

FIG. 4 illustrates an exemplary data quality specification, according to an embodiment of the present invention.

FIG. 5 illustrates harvesting content, according to an embodiment of the present invention.

FIG. 6 illustrates filtered options, according to an embodiment of the present invention.

FIG. 7 illustrates execution pathing, according to an embodiment of the present invention.

FIG. 8 illustrates an exemplary results presentation, according to an embodiment of the present invention.

FIG. 9 illustrates an exemplary interface, according to an embodiment of the present invention.

FIG. 10 illustrates an exemplary interface, according to an embodiment of the present invention.

FIG. 11 illustrates an exemplary interface, according to an embodiment of the present invention.

FIG. 12 is an exemplary data governance technology stack, according to an embodiment of the present invention.

FIG. 13 is an exemplary illustration of Metadata-driven data governance, according to an embodiment of the present invention.

FIG. 14 is an exemplary system diagram, according to an embodiment of the present invention.

FIG. 15 is an exemplary system diagram for on-demand data quality processing, according to an embodiment of the present invention.

FIG. 16 illustrates an exemplary on-demand data quality user interface, according to an embodiment of the present invention.

FIG. 17 is an exemplary illustration of a data in-flight data quality process, according to an embodiment of the present invention.

FIG. 18 is an exemplary flowchart for a data quality in-flight process, according to an embodiment of the present invention.

FIG. 19 is an exemplary illustration of a data in-flight data quality process, according to an embodiment of the present invention.

FIG. 20 is an exemplary system diagram of a data quality in-flight with configurable actions, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

A challenge in the industry is when bad data is used in a process that is then relied upon by decision makers within a company. Data quality, which may be considered part of data governance, addresses where the data came from, the quality of the data, the quality of the data after the data transformation, etc. Current efforts and resources to manage and maintain data quality within an expected timeframe can be overwhelming and unsustainable.

An embodiment of the present invention is directed to a Metadata-Driven Data Quality Framework and Engine (which may be referred to as “DQ Framework”). The DQ Framework enables dynamic generation of code for assessing data quality based on qualified metadata content.

An entity (e.g., company) seeking to leverage its data to drive business decisions and strategy will want to ensure that the data being leveraged is appropriate, accurate, and complete. This may be accomplished by identifying a set of desirable characteristics for the data and then comparing the values of the data against the set of characteristics. Generally, data quality may be defined by the presence of a preponderance of desirable characteristics or absence of undesirable characteristics. Characteristics may relate to completeness (e.g., sparsity or missing values); accuracy (e.g., reflects what was intended); timeliness (e.g., realistic and align dates); consistency (e.g., values align within and across systems); and conformity (e.g., system attributes and formats align). Various techniques may be supported including canned assessments (e.g., standard rules run on important data including nulls, value ranges, reasonableness); data profiling (e.g., overall content compared historically); and custom rules (e.g., additional rules testing conformity and consistency). Results may be presented in various formats including comparison of thresholds to determine failure, publicly available information, requirement that initiates issue resolution as well as other actions, warnings, and information.

This process of comparing data to its desirable characteristics may be referred to as the data governance discipline of assessing data quality. A goal of data quality may relate to determining accuracy and completeness of the data and then communicating those findings to a broader data user community.

Data Governance may refer to a multi-disciplinary function within a broader data management function that seeks to ensure the transparency and consistency of the data required by critical business activities. For example, Data Governance may represent a formal discipline that manages the data from an asset perspective much like a Facility Manager managing a facility.

A challenge that an embodiment of the present invention seeks to address relates to delivering on data quality effectively and efficiently such that the total cost of ownership of the assessments do not negate the value of programmatically assessing the data’s quality.

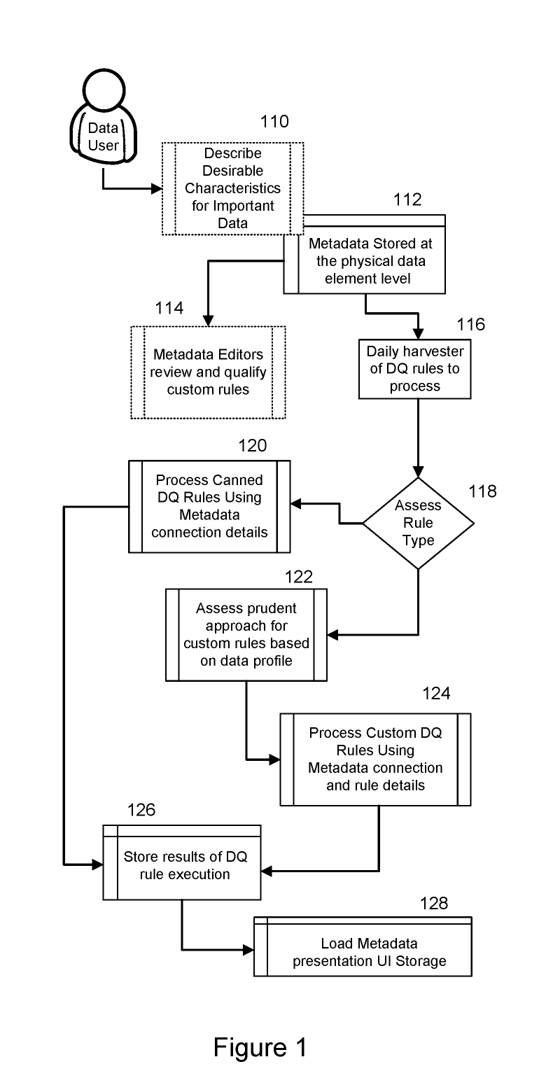

FIG. 1 is an exemplary flowchart of an overall architecture, according to an embodiment of the present invention. At step 110, a data user may describe one or more desirable characteristics for important data. The characteristics may also be automatically obtained through a data source or system.

At step 112, metadata may be stored at a physical data element level. According to an embodiment of the present invention, metadata refers to conveying knowledge, understanding, and accountability for data. For example, Address Line One Text is linked to the business term for Addressee Name, which may be defined as the customer to whom the correspondence is to be delivered. According to another example, data quality rule metadata may include the following: Business Name: Addressee Customer Validity; Business Description: All addressees must be validly present within our master domain of customers; Technical Description: Select address_line_1_txt from master_customer_data where golden_flg=’Y’; Frequency: Daily; Priority Critical; Yellow Threshold: 99.99%; Red Threshold: 99.8%. Data are known facts or things used as a basis for inferencing or reckoning. Therefore, metadata is an expression of the essential meaning of the data through descriptive and contextual annotation from the business data consumers point-of-view. Contextual context may include projects affecting the data, processes that leverage the data, the understanding Information Technology (IT) or other technology team had when building the physical object (e.g., tradition data dictionary), or the expectations and meaning of the data’s quality. Data dictionary may represent a repository of understanding from a technical perspective and its purpose is to document what the solution builder understands what it is they are building. Therefore, the terminology and standards are much looser than that of metadata and may be meaningful to IT but not so complete from a business perspective.

At step 114, metadata editors may review and qualify custom rules. The process of developing custom data quality rules may involve assessing data’s health according to some other characteristics or comparisons within the data itself. While there can be any number of custom rules for any given data element, the types of tests may fall into one of the following categories: Consistency (e.g., distribution check, negative check override, date history override, date future override); Accuracy (e.g., business validation, valid value check); Completeness (e.g., null override, process validation); and Conformity (e.g., number of rows check, distinct number of rows check, minimum value count check, maximum value count check, minimum value check, maximum value check, summation check). Other types of tests may be applied based on various other applications, scenarios, industries, etc.

At step 116, daily harvester of DQ rules may collect technical metadata that relate to technical specification, frequency of execution and thresholds. For example, daily harvester may represent a process that repeats on a 24 hour clock (or other predetermined cycle) to collect existing and new content from the data quality metadata and present the content to a data quality engine. At step 118, rule type may be assessed. Rule types may include canned rules, custom rules, complex rules, etc. For example, rule types may be leveraged to categorize the harvested data quality rules to determine an optimal (or most prudent) method for processing the code based on complexity of the rule and a simple assessment of the data’s profile for volume.

Step 120 may process canned DQ rules using metadata connection details. Using the above example from step 112, within the metadata may also exist a data catalog. The data catalog may represent a collection of physical details for each piece of data stored. Critical details may include: Database Name, Schema Name, Table Name, Column Name, and Column Type. The DQ Framework may leverage this information to determine a technical connection required to the data in order to process the data quality rule. For example, Customer_MDM; Customer_Ord; Customer; Customer Name.

Canned rules may represent highly structured assessments where the only difference is what data element to process against. These rules are by the type of data elements (e.g., character, numeric, or date) and the logic will not change. Canned rules may refer to numeric data (e.g., mean check, median check, mode check, range check, negative check); date (e.g., too old check, too new check, validity check); string (e.g., junk character check); regardless of data type (e.g., null count, data pattern count, observed data type, average length, unique row count), etc.

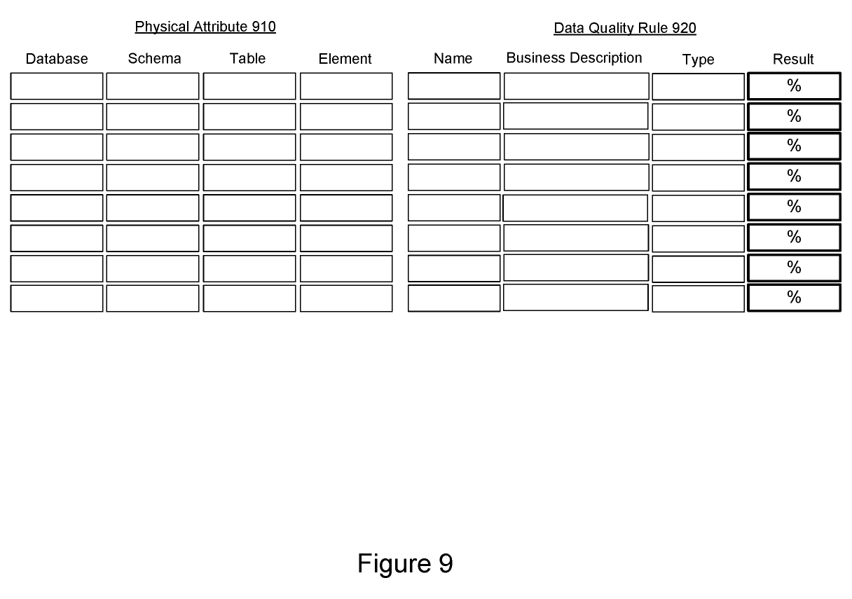

Step 122 may assess a prudent approach for custom rules based on data profile. An embodiment of the present invention recognizes that there are numerous ways to approach the execution of a data quality rule script. Some approaches may be considered better than others based on type and volume of data. Step 122 may leverage the type of data (e.g., text, number, dates, binary large objects, etc.) along with an expected number of rows based on historical trends or initial volume to determine whether a multi-threaded or single threaded approach is appropriate. Step 124 may process custom DQ rules using metadata connection and rule details. Step 126 may store results of DQ rule execution. Step 128 may then load metadata presentation to UI storage. FIGS. 9, 10, and 11 below represent illustrations of how data quality results may be presented, with a focus on the integration and connection of data quality rules to their results within a business context. While the process of FIG. 1 illustrates certain steps performed in a particular order, it should be understood that the embodiments of the present invention may be practiced by adding one or more steps to the processes, omitting steps within the processes and/or altering the order in which one or more steps are performed.

As the global economy becomes more and more dependent upon data, a company’s success may be directly tied to the quality of the data that they use. While this solution provides very valuable insights into the quality of the data, an embodiment of the present invention may be extended to support an organization’s desire to use data to drive decisions, revenue and other business objectives and goals.

An embodiment of the present invention is directed to assessing whether data is fit for a particular purpose. For some applications, this goes beyond an individual data element’s quality. The Data Quality Framework may capture the very definition of “fit for purpose” within the metadata, which means the integration of lineage (e.g., data pipeline), reconciliation of the data throughout the pipeline, the statistical variations of the data over time, and an alignment assessment of the data to the intended purpose may be included within the output analysis.

According to an embodiment of the present invention, the Data Quality Framework may leverage metadata, data profiles, individual data quality results, and the data pipeline with a standardized, complex analyses to arrive at the fitness of the data used in a process or analytic project, automatically through this simple metadata.

Generally, data quality tools focus on the Information Technology solution to build, deploy code, schedule processes, and execute data quality rules. These results are then made available for the manual determination of fitness, which often excludes the many other components that determine true fitness. According to an embodiment of the present invention, the Data Quality Framework focuses on the metadata to drive that activity so the business can spend more time using the data than waiting for quality results and manual fitness assessments.

According to an embodiment of the present invention, the Data Quality Framework may be directed to an enterprise scaled application that embodies Data Quality disciplines for good and/or optimal Data Governance. An embodiment of the present invention may be integrated into a Metadata Management process of an overall Data Governance Program so the data user’s meaning and understanding may become part of the automated data quality process. Other implementations and infrastructures may be supported.

According to an embodiment of the present invention, the Data Quality Framework enables greater reuse of data user knowledge and understanding while shortening the overall implementation of data quality assessments on an enterprise scale. Additionally, through the transparency into the metadata rules, the Data Quality Framework increases the productivity of involved users/participants and significantly reduces the costs and/or resources to build and sustain the data quality rules.

An embodiment of the present invention seeks to simplify and expedite time to market for data quality rules and further facilitates data quality management. An embodiment of the present invention is directed to a Data Quality Framework that processes and translates metadata into a programming language that business users can access and interact with. For example, business users may provide inputs in natural language and other defined formats. The Data Quality Framework dynamically builds the code based on the metadata. The code may then be executed based on a schedule that defines when and how often the code should be run.

An embodiment of the present invention may receive criteria for good data quality through an interface of a Data Quality Framework. This may be in various formats such as good/bad characteristics. The Data Quality Framework may then generate data quality requirements and corresponding metadata. The metadata may include the information concerning the data that the Framework will run the rules against. The Framework provides an ability to connect and access the metadata, wherever it may be stored, and may further plug into any metadata source/engine. The Data Quality Framework receives, processes and/or translates the metadata (using JSON, for example) to then automatically generate and execute corresponding code. Using the metadata enables the Framework to verify specifics, provide more transparency and control over data quality.

The Data Quality Framework may be platform agnostic and support various implementations including cloud services. An embodiment of the present invention may be used to drive business focus and attention. For example, the Framework may identify alert conditions based on exceeded thresholds. These conditions may direct business users where to focus to improve data quality and avoid use of risky or bad data. An embodiment of the present invention may rely on various sources of data, including data repositories, flat files, XML files, database tables, reports, etc.

An embodiment of the present invention may overlay quality of data on business process steps. If a data quality analysis was performed on data used in a process step, an embodiment of the present invention may overlay or associate quality of data with that process step. This information may then be extended to other steps for improved data quality and awareness. Data quality overlay may apply to nodes in a graph database where data quality may be associated with a node that processed the underlying data. Other process steps and applications may be supported.

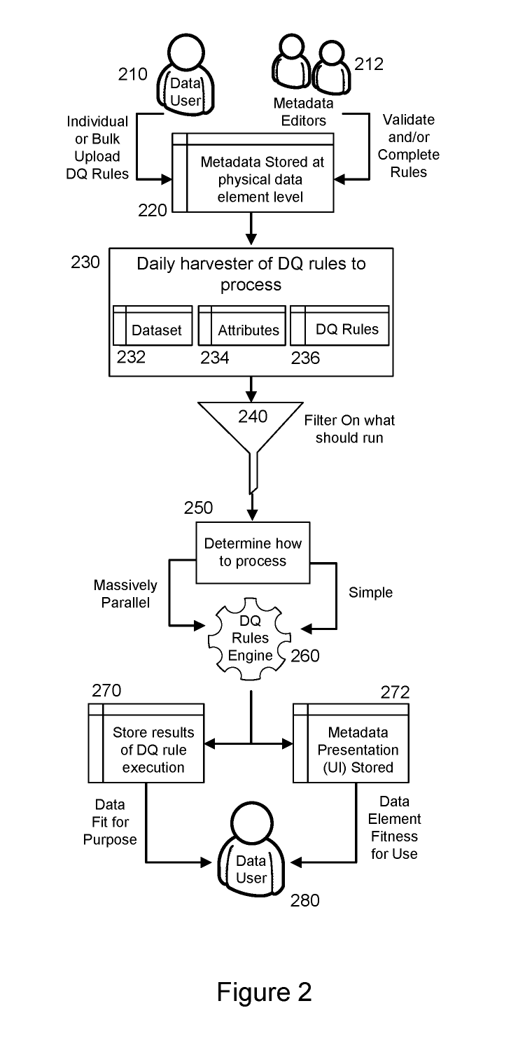

FIG. 2 is an exemplary flowchart of an overall process, according to an embodiment of the present invention. According to an embodiment of the present invention, the Data Quality Framework may represent a combination of reduced manual intervention and leveraging of centrally and stored documentation regarding the meaning and understanding of the data (e.g., metadata).

As shown in FIG. 2, Data User 210 may perform individual or bulk uploads of data quality (DQ) rules. At this step, a user may submit a request for a new DQ rule and also identify characteristics associated with data quality assessment.

Metadata Editors 212 may validate and/or complete rules. Using the Data Quality Framework, Metadata Editors 212 may determine an appropriate rule for a new DQ rule request. Rules may include simple rules, canned rules as well as complex rules of varying degree. An embodiment of the present invention may then convert the rule into code (e.g., JSON) which may then be saved.

Metadata may be stored at a physical data element level at 220. Daily harvester of DQ rules may be processed at 230. Harvesting may refer to collecting technical metadata including Dataset 232, Attributes 234 and DQ Rules 236. In this example, DQ Rules 236 represent existing rule metadata. At a predetermined schedule (e.g., every morning), the Framework may execute rules which may include recognizing a new rule that will be executed according to a schedule and/or frequency (e.g., daily, weekly, monthly, condition-based, etc.).

Filters may be applied at 240. For example, relevant filters or routers may include data volume to be read for processing, date of last data quality rule execution, complexity of the rules to process, etc. A determination of how to process the filtered data may be applied at 250. This may include determining between massively parallel or simple processing. Other processing techniques may be applied. DQ Rules Engine 260 may be invoked. Results of DQ rule execution may be stored as shown by 270. Metadata presentation (via a user interface (UI)) may be stored as shown by 272. Data (e.g., data fit for purpose; data element fitness for use, etc.) may be communicated to Data User 280. While the process of FIG. 2 illustrates certain steps performed in a particular order, it should be understood that the embodiments of the present invention may be practiced by adding one or more steps to the processes, omitting steps within the processes and/or altering the order in which one or more steps are performed.

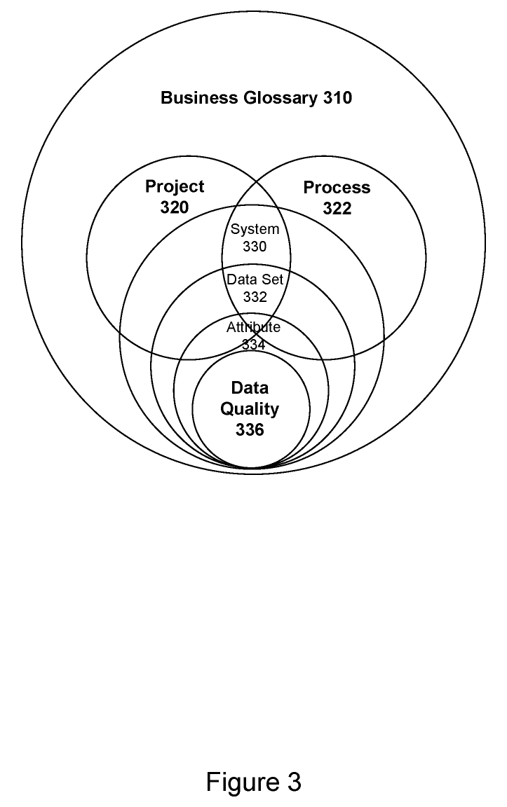

FIG. 3 illustrates metadata types and relationships, according to an embodiment of the present invention. Metadata types may include: Business Glossary 310; Project 320; Process 322; System 330; Data Set 332; Attribute 334; and Data Quality 336. Other types and relationships may be realized.

Business Glossary 310 provides a business context for data and a relationship of that context to its physical incarnation within a database, report, or flat file. This business context may provide a common lexicon for all to leverage when referring to the data to reduce the risk of using the wrong data.

An embodiment of the present invention recognizes that the meaning of the data, e.g., the metadata, cannot be understood without input from a knowledgeable data user. The Data Quality Framework may require that the business and technical meaning of the data be stored centrally for internal enterprise usage. This may be referred to as Metadata application. Examples may include data governance platform, data integration platforms, data catalog tools, etc.

An embodiment of the present invention may receive actual metadata (e.g., mainly technical content such as table, column names, schema, etc.) as well as additional inputs such as process controls, roles, and responsible parties. Data quality rules may be applied to an actual technical content. In addition, an embodiment of the present invention may provide a declaration of what data attributes are important to the business.

A data quality requirement may include capturing data quality (DQ) rules. In some examples, this may include a manual capturing of DQ rules. If captured properly, these requirements may be reused for similar important data attributes in an efficient and streamlined manner.

An embodiment of the present invention may receive the technical metadata and those attributes deemed important, existing data quality rules (e.g., canned, complex, etc.). In some examples, a data user may communicate what it is they need assessed for quality and how they would like to go about that assessment.

An embodiment of the present invention may be directed to completing the data quality requirement with a title of the DQ rule, a business description of what is being tested, how often, and other technical content the data user may have to describe any calculations or tests.

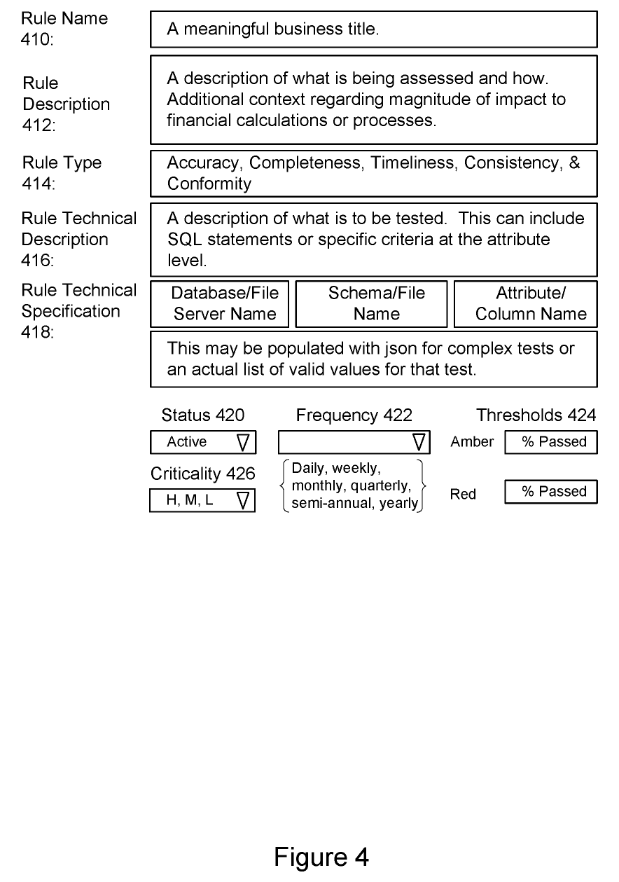

FIG. 4 illustrates an exemplary data quality specification, according to an embodiment of the present invention. When necessary, a data quality specification may be required to articulate the business specification into the appropriate language of the DQ Framework (.json) for execution.

A data quality specification may include the actual objectives of the data quality assessment and any other content provided to describe the rule. In addition, an embodiment of the present invention may generate the code for the rule tested and converted into the appropriate language.

FIG. 4 illustrates the metadata content associated with a data quality rule. As shown in FIG. 4, content may include: Rule Name 410, Rule Description 412, Rule Type 414, Rule Technical Description 416, and Rule Technical Specification 418. Other details may include Status 420, Frequency 422, Thresholds 424 and Criticality 426.

Rule Name 410 may include a meaningful business title.

Rule Description 412 may include a description of what is being assessed and potentially how. Additional context regarding the magnitude of the impact of financial calculations or processes may be included.

Rule Type 414 may include accuracy, completeness, timeliness, consistency and conformity. Other rule types may be available to support other applications, scenarios, etc.

Rule Technical Description 416 may include a description of what is to be tested. This may include SQL statements and specific criteria at the attribute level, for example.

Rule Technical Specification 418 may reference physical assets, including Database/File Server name, schema/file name, attribute/column name, for example. This may include json (or other file format) for complex tests, actual list of valid values, etc. Other details may include Status 420 (e.g., active, inactive, etc.), Frequency 422 (e.g., daily, weekly, monthly, quarterly, semi-annual, yearly, etc.), Thresholds 424 (e.g., percentage passed) and Criticality 426 (e.g., high, medium, low).

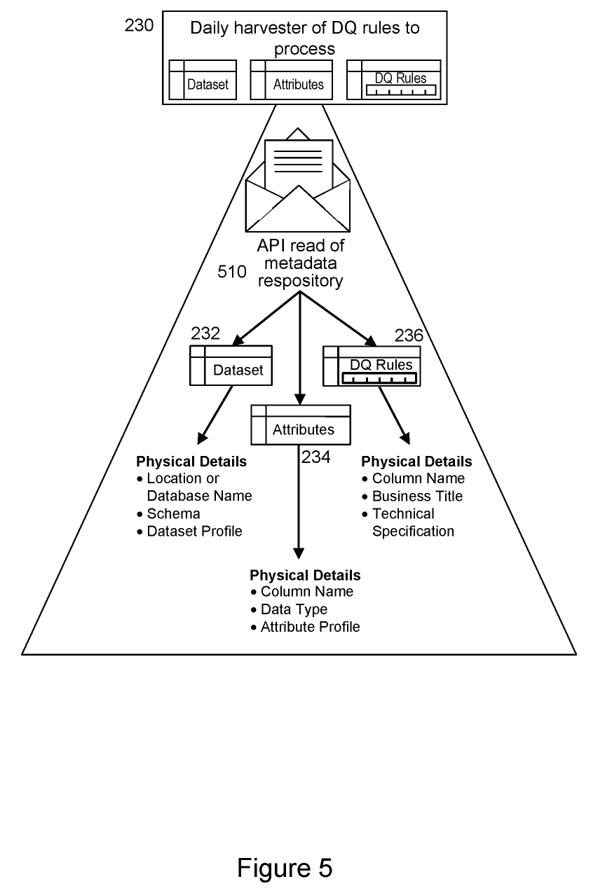

FIG. 5 illustrates harvesting content, according to an embodiment of the present invention. More specifically, FIG. 5 illustrates an exemplary process of collecting technical metadata for data quality rules external to its main central storage repository for the purpose of building an execution plan and then running the rules against the target data. As shown in FIG. 5, 510 may represent an API read of metadata repository. Dataset 232 may include physical details such as location, database name, schema, dataset profile, etc. Attributes 234 may include column name, data type, attribute profile, etc. DQ Rules 236 may include column name, business title, technical specification, etc.

Daily harvester of DQ rules to process 230 may receive technical metadata to include the technical specification, frequency of execution, and Amber/Red thresholds and then generate the rules that are run on a given day or other time period/condition.

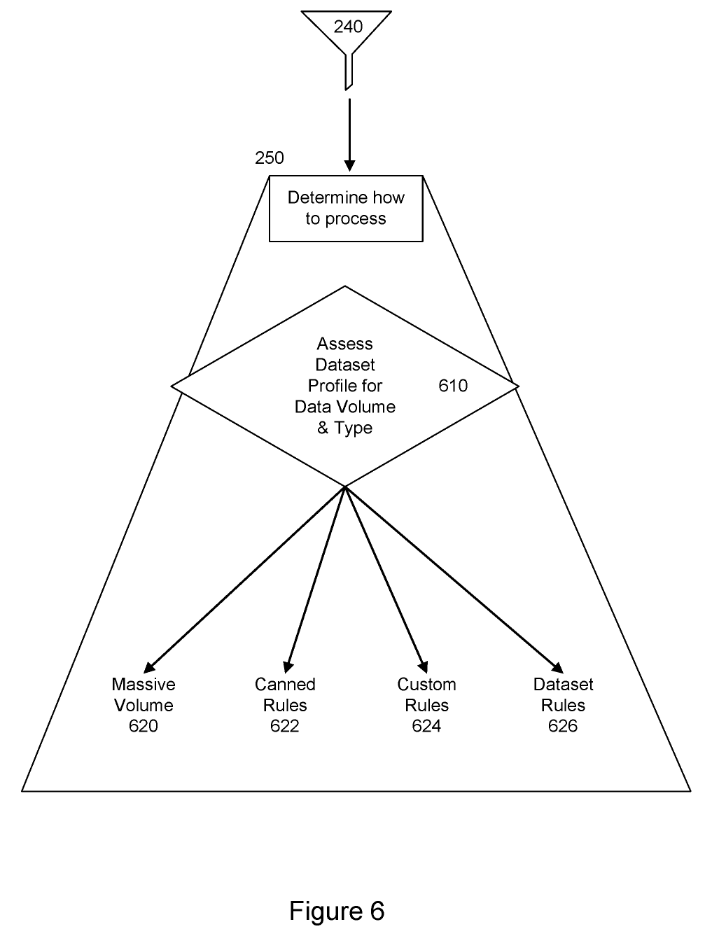

FIG. 6 illustrates filtered options, according to an embodiment of the present invention. FIG. 6 illustrates a process of determining which DQ Framework process flow to utilized for processing. Data is filtered at 240. The system then determines how to process the filtered data at 250. As shown by 610, dataset profile may be assessed for data volume, type and/or other characteristics.

An embodiment of the present invention may receive the DQ rules to execute and the profile of the data being tested, e.g., data volume, other critical profiling metrics, etc. and then generate the execution plan for the data quality rules and the initiation of the actual process of assessing the quality of the data.

The various rules may include Massive Volume 620, Canned Rules 622, Custom Rules 624 and Dataset Rules 626. Other rules may be generated and/or identified to support other applications, scenarios, etc.

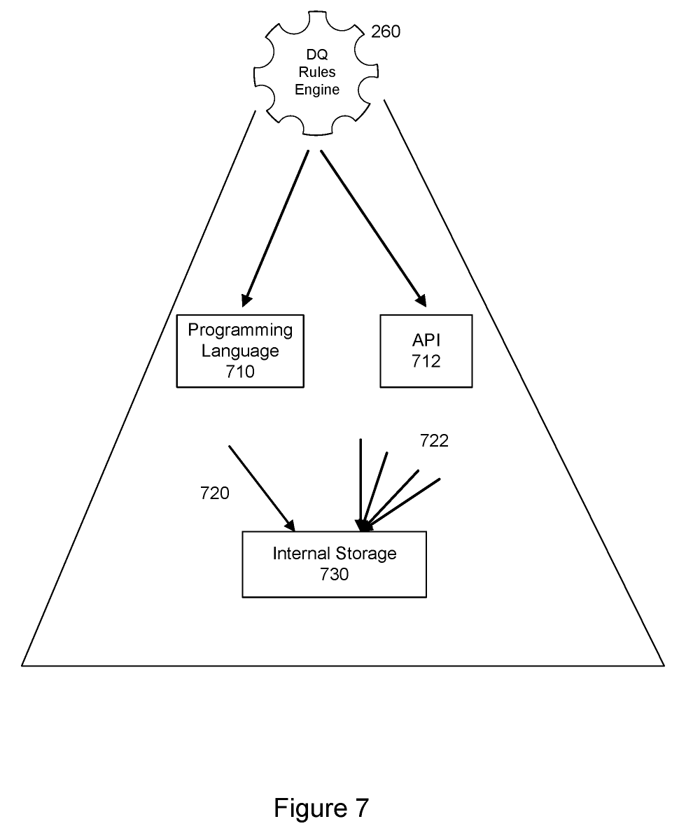

FIG. 7 illustrates execution pathing, according to an embodiment of the present invention. An embodiment of the present invention may be directed to capturing outcomes of data quality assessments to facilitate analytics and provide more robust data quality assessments.

Programming Language 710 represents a computer programming language, such as Python.

API 712 represents an interface for a distributed computing framework and a set of libraries for real-time, large scale data processing and other applications in the computer programming language.

720 and 722 represent various executions performed on the internal storage data, represented by 730.

An embodiment of the present invention may receive the actual results of the DQ assessments and then generate the results by data quality rule that are time stamped to assess trends and/or compare statistical variations.

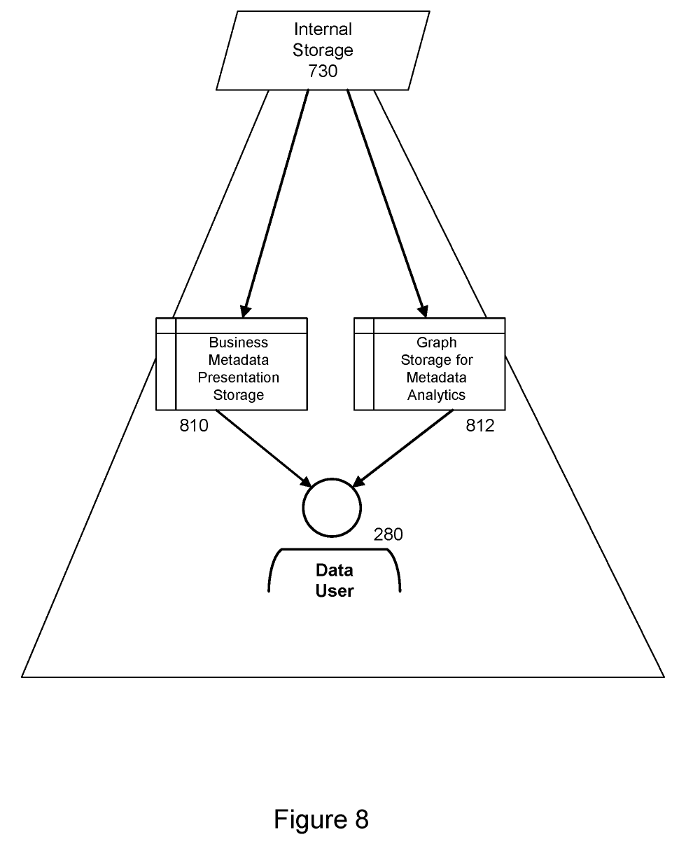

FIG. 8 illustrates an exemplary results presentation, according to an embodiment of the present invention. An embodiment of the present invention is directed to presenting the current results of the assessments through a user interface or other communication medium. This may be supported in various implementations, including as a standalone report in Power BI, SAP Business Objects, etc. The results may also be presented by integrating the recently executed rule results within the data quality metadata.

An embodiment of the present invention may receive an internal storage of the DQ Framework results and then generate integrated DQ results with the Metadata Application, a dashboard of the results, etc. By integrating data quality results, an embodiment of the present invention is directed to representing the results in various ways.

FIG. 9 illustrates an exemplary interface, according to an embodiment of the present invention. FIG. 9 presents individual rule results. This may include Physical Attributes 910 including Database, Schema, Table and Element. Data Quality Rule 920 may include Name, Business Description, Type and Result. Result may be represented as a percentage.

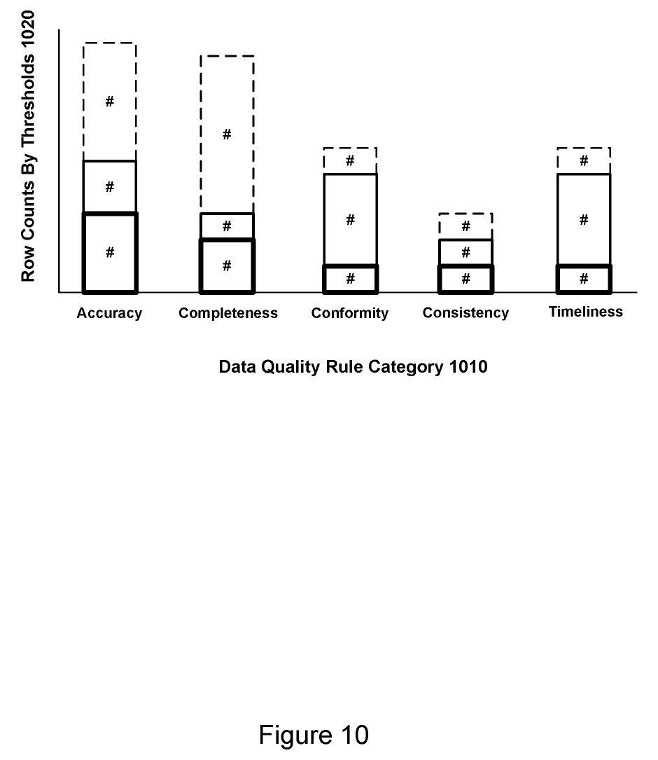

FIG. 10 illustrates an exemplary interface, according to an embodiment of the present invention. FIG. 10 illustrates data quality rule categories 1010. In this example, FIG. 10 represents row counts by thresholds 1020 for various categories, including Accuracy, Completeness, Conformity, Consistency and Timeliness. The categories illustrated are merely exemplary and other categories may be supported. The different portions may represent different threshold severity levels.

Quality data may be defined as being fit for use, meaning that it has features and characteristics that are in alignment with what the business data user expects or understands. The idea of data quality as a discipline resolves around understanding the meaning of the data and knowing what is expected. There are several dimensions of data quality that may be deployed to determine a sufficient presence of those characteristics that yield an understanding of the data’s fitness. These may include accuracy, completeness, conformity, consistency, and timeliness.

Accuracy represents a dimension of data quality that assesses if the data measures to the “real-world” or model expectations for the values available matching what is expected. This may include: incorrect spellings of product or person names, addresses, and even untimely or not current data can impact operational and analytical applications. Default profiling rules testing this dimension of DQ may include the custom business rules and valid value rules.

Completeness represents a dimension of data quality that assesses if the data is missing, or in an unusable state. In some cases, missing data is irrelevant, but when the information that is missing is critical to a specific business process, completeness becomes an issue. Default profiling rules testing this dimension of DQ may include the null and null override rules.

Conformity represents a dimension of data quality that assesses if the data values conform to specified formats. If so, do all the values conform to those formats? Maintaining conformance to specific formats is important in data representation, presentation, aggregate reporting, search, and establishing key relationships. Default profiling rules testing this dimension of DQ may include the string pattern and string length rules. Conformity may also refer to reconciling data from one repository to another.

Consistency represents a dimension of data quality that assess if distinct data instances provided conflict with information about the same underlying data elsewhere. Are values consistent across data sets? Do interdependent attributes always appropriately reflect their expected consistency? Inconsistency between data values plagues organizations attempting to reconcile between different systems and applications. Default profiling rules testing this dimension of DQ may include the number range and string junk rules.

Timeliness represents a dimension of data quality that assess whether the data represents the reality at the specified point in time. Is the data too far into the past or future? Default profiling rules testing this dimension of DQ may include the date history and future rules.

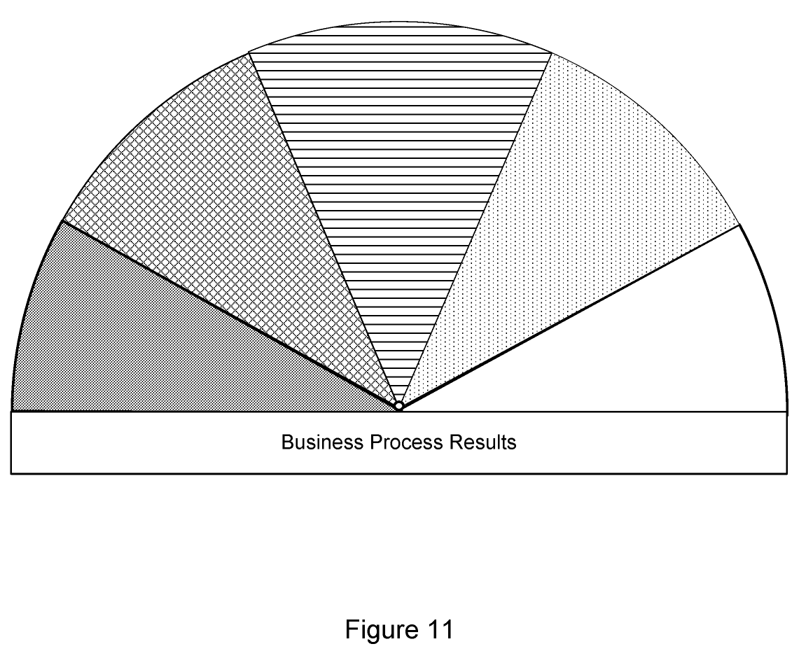

FIG. 11 illustrates an exemplary interface, according to an embodiment of the present invention. FIG. 11 represents business process results where related results may be aggregated. As shown in FIG. 11, attribute level results may be aggregated into a single score based on the metadata for that business process. This aggregate value may then be mapped to its corresponding value on a scale, e.g., scale of 1 to 5. This gauge is illustrative only and is meant to be a simple illustration of the viability of the data leveraged in the defined business process. The darker shaded sections (on the left) may indicate a riskier situation where the data is unreliable. The lighter sections (on the right) may represent high data quality and reliability. The shaded sections in between may represent varying risk and quality of data. Other graphics and illustrations in varying detail and granularity may be provided via a user interface.

By leveraging a Business Metadata Application, an embodiment of the present invention realizes various benefits and advantages. Benefits of metadata-driven data quality may include: less time articulating requirements; code reusability; metadata content reusability; does not require a separate initiative to report results or ensure all that can or should know have access to the report; through the centralizing content anyone who might be interested in the data is granted a line of sight into something they may not know about the data; extremely fast turn-around as these data quality check requirements are simple documentation with no coding; and highly efficient processing enables an alignment of data quality assessments to the underlying data’s volatility.

According to an embodiment of the present invention, the Data Quality Framework may integrate into existing business metadata management. For example, the DQ Framework enables data users to describe their data quality check once and see the results come out with potentially the shortest time to market for any rule depending upon its complexity. While the DQ Framework integrates with any REST API enabled business metadata application for the presentation of results, an embodiment of the present invention provides the ability to view and leverage those results while searching the data catalog for the right data to leverage.

An embodiment of the present invention may leverage various technologies and deployments including opensource technologies. For example, the Data Quality Framework may be a feature within a broader data governance product, such as a MetaGraph product. The MetaGraph product provides the ability to navigate the data lakes and seas. MetaGraph represents a system within which the Data Quality Framework may operate. MetaGraph provides all of the detail regarding the meaning and understanding of the data so that the business may obtain the maximum value from its data. MetaGraph has three primary modules, including Metadata Hub, MetaLake, and MetaMotivate. Metadata Hub may represent an interface to access the meaning and fitness of data. MetaLake may represent a single source/repository for finding the truth about the meaning and fitness of data. MetaMotivate may represent an integrated engine that generates new metadata content.

The Data Quality Framework may represent a component of MetaMotivate, which provides for the energy necessary to power the MetaGraph precision instrument through processes, machine learning and analytics on the metadata. MetaLake delivers a robust repository of meaning and understanding content regarding the data structured according to support business needs. Metadata Hub enables any data user to leverage the collected and derived content to find the data needed to deliver trusted, quality results on time. Other implementations may be supported.

For example, the MetaGraph may perform machine learning on top of metadata to drive the creation of metadata and fulfillment of quality and other qualities of governance. MetaGraph seeks to facilitate the ability of making data discoverable and then applying machine learning and other processing to determine which data to use in terms of data quality (e.g., use this data instead of that data).

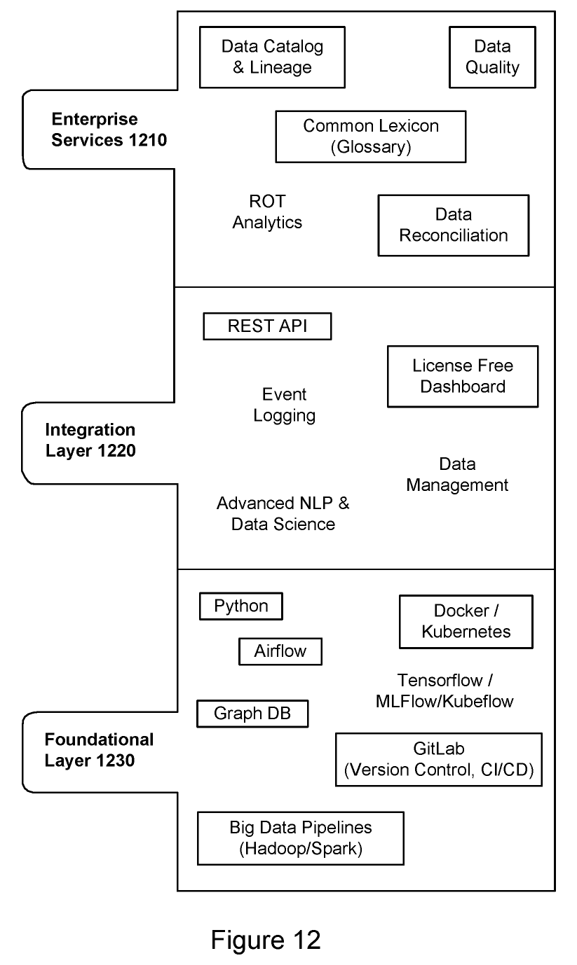

FIG. 12 is an exemplary data governance technology stack, according to an embodiment of the present invention. FIG. 12 illustrates the open-source nature of the solution and the minimalist approach to the overall footprint and costs for the solution. FIG. 12 illustrates Enterprises Services 1210, Integration Layer 1220 and Foundational Layer 1230.

An embodiment of the present invention may support various deployments. The system may be fully cloud ready as well as deployable on premises at a company’s data center.

If deploying on-premises, there may be a need for a Kubernetes cluster sized appropriately for the volume of data for the data catalog. In addition, connectivity to various data repositories where quality rules will be processed may be set up independently.

While the Data Quality Framework is a component of a broader Data Governance product offering, it may remain a standalone application and as such has its distinctive roadmap.

According to an embodiment of the present invention, the DQ Framework may be represented as an autonomous product that includes a standalone metadata repository for technical content and specifications. Additionally, this product may read the metadata platform, extract which data elements that will have quality assessments executed, and on what schedule.

An exemplary process may deal directly with canned rules, valid value rules, and customer rules. According to an exemplary illustration, a process optimizer may be implemented to determining which approach to follow.

An embodiment of the present invention may include a presentation of the results according to its metadata.

An exemplary illustration may use data governance tool and a business metadata repository, as such REST APIs exist to get data from and into the repository.

An embodiment of the present invention may be directed to enabling a broader enterprise scaled scheduling of various processes according to the profile of the data to be assessed. A Predictive Schedule Optimizer may leverage simplistic profiles of the data (e.g., row counts) to assess if a multi-threaded approach is warranted.

An embodiment of the present invention recognizes that there are numerous data quality assessments that are best left at the dataset level. These are statistical deviations from prior runs which may be realized to offer a broader but more detailed reconciliation over time, as well as a reconciliation between sources and targets of a data pipeline.

An assignment Group may be applied to determine to whom an issue should be sent based on the data’s lineage from where it was assessed.

Lineage may refer to a type of metadata that describes how data moves from one location to another location. Here, location refers to a data repository, flat file, report, or query. Lineage may represent a depiction of the pipeline created to deliver the data to the ultimate data consumer. For example, lineage may identify data that has been transformed a number of times.

Given that the metadata indicates at what percentage of failing records determines an issue, Issue Management Integration may be applied to extract the metadata for the rule (e.g., title, description, technical description and specification, results, etc.) and prepare it for a given issue management tool.

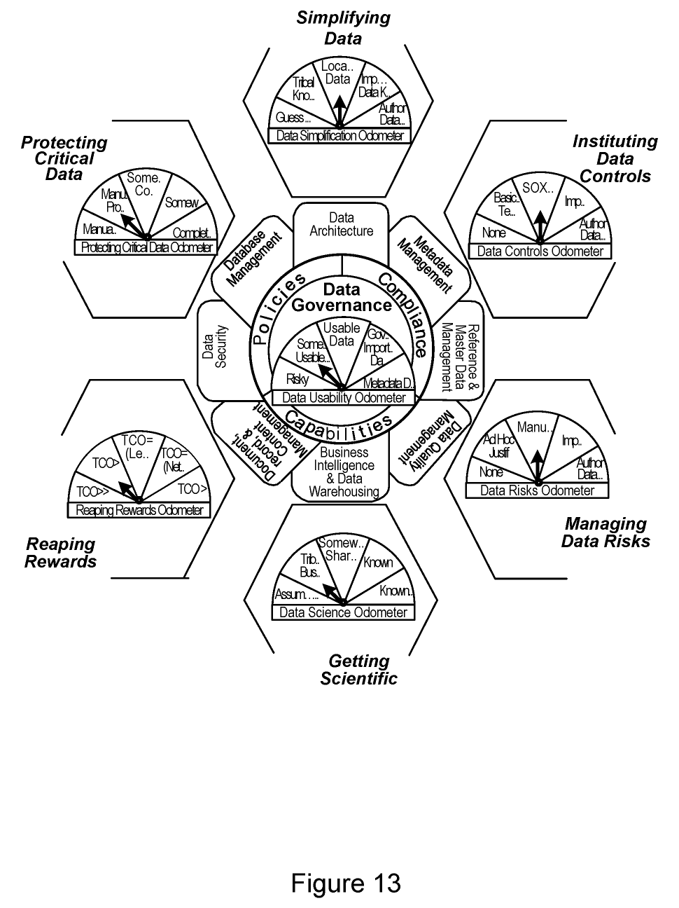

FIG. 13 is an exemplary illustration of Metadata-driven data governance, according to an embodiment of the present invention.

MetaGraph enables efficient and effective data governance that yields meaningful results that are intuitive and immediately applicable to the prevailing business needs for action, direction and decisions. While understanding data’s quality, meaning, lineage and accountability, provides value in and of itself, Metadata Hub (e.g., an interface to access the meaning and fitness of data) enables any data user to leverage the collected and derived content to navigate and find the data needed to deliver quality results on time. The precision necessary to drive business decisions dictates that there is sufficient content across all facets of business meaning. The MetaLake (e.g., a single source/repository for finding the truth about the meaning and fitness of data) delivers a robust lake of meaning and understanding regarding the data to support business needs. The MetaMotivate (e.g., an integrated engine that generates new metadata content) provides the energy necessary to power the MetaGraph precision instrument through processes, machine learning and analytics on the metadata.

MetaGraph leverages user provided metadata, machine learned metadata and accompanying data analytics to assess the business’ understanding of the data and thereby certify the results. As shown in FIG. 13, Data Governance may include Policies, Compliance and Capabilities. Features and functions may include: data architecture; metadata management; reference and master data management; data quality management; business intelligence and data warehousing; document, record and content management; data security and database management. Results may be realized through simplifying data; instituting data controls; managing data risks; getting scientific; reaping rewards; and protecting critical data. The results may be communicated through various interfaces and graphics, such as odometers illustrated in FIG. 13. A Data Usability Odometer provides a graphic that illustrates the overall usability of the data. For example, data may be categorized as risky, somewhat useable, usable data, governed important data, metadata-driven data utilization. A similar graphic may be applied for each of the results. Other graphics and scales may be implemented.

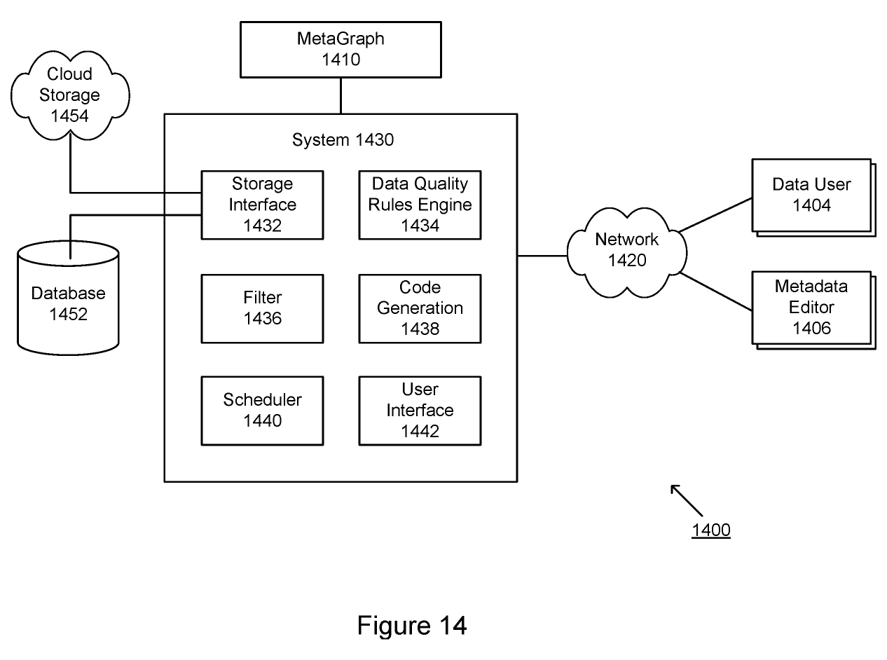

FIG. 14 is an exemplary system diagram, according to an embodiment of the present invention. FIG. 14 illustrates System 1430 that executes Data Quality Rules Engine 1434. System 1430 may manage data quality and rules generation for various entities and may be part of a larger data governance system, such as MetaGraph 1410. System 1430 may interact with MetaGraph 1410 as an integrated system/component or as a third-party service entity. Other implementations and relationships may be realized.

System 1430 may support various functions and modules including Storage Interface 1432, Data Quality Rules Engine 1434, Filter 1436, Code Generation 1438, Scheduler 1440 and User Interface 1442.

Storage Interface 1432 may interface with one or more storage components, such as Database 1452, Cloud Storage 1454, etc. Storage Interface 1432 may manage various forms of data including rules, metadata, code, etc.

Data Quality Rules Engine 1434 may generate various types of rules to determine data quality. Rules may include canned rules, custom rules, complex rules, etc.

Filter 1436 may apply various filters to refine the data.

Code Generation 1438 enables dynamic generation of code for assessing data quality based on qualified metadata content.

Scheduler 1440 may execute rules based on frequency, a predetermined schedule, conditions and/or other criteria.

User Interface 1442 may enable users and/or other entities to interact with Data Quality Rules Engine 1434. User Interface 1442 may include browser or other user interactive interface. User interaction may be supported through various user devices, including computers, laptops, mobile devices, smartphones, tablets, etc.

According to an embodiment of the present invention, the Data Quality Rules engine may leverage metadata to generate a programmed data quality rule. As discussed above, the data quality rules may be simple (e.g., column a cannot be null for the most recent row of data) as well as progressively more complex (e.g., data entered for this column must be between 50 and 100 for the most current data available or the data in field “A” must be a value of “25” when filed “B” is True and Field “C” from another table is “Y”).

Users may interact with System 1430 via Network 1420. User may include Data Users 1404, Metadata Editors 1406 as well as other participants Database 1452 and Cloud Storage 1454 may store and manage data relating to data quality, including rules, metadata, etc. Various forms of data may be stored and managed.

The system 1400 of FIG. 14 may be implemented in a variety of ways. Architecture within system 1400 may be implemented as hardware components (e.g., module) within one or more network elements. It should also be appreciated that architecture within system 1400 may be implemented in computer executable software (e.g., on a tangible, non-transitory computer-readable medium) located within one or more network elements. Module functionality of architecture within system 1400 may be located on a single device or distributed across a plurality of devices including one or more centralized servers and one or more mobile units or end user devices. The architecture depicted in system 1400 is meant to be exemplary and non-limiting. For example, while connections and relationships between the elements of system 1400 are depicted, it should be appreciated that other connections and relationships are possible. The system 1400 described below may be used to implement the various methods herein, by way of example. Various elements of the system 1400 may be referenced in explaining the exemplary methods described herein.

Network 1420 may be a wireless network, a wired network or any combination of wireless network and wired network. Network 1420 may further include one, or any number of the exemplary types of networks operating as a stand-alone network or in cooperation with each other. Network 1420 may utilize one or more protocols of one or more network elements to which it is communicatively coupled. Network 1420 may translate to or from other protocols to one or more protocols of network devices. Although Network 1420 is depicted as one network for simplicity, it should be appreciated that according to one or more embodiments, Network 1420 may comprise a plurality of interconnected networks, such as, for example, a service provider network, the Internet, a cellular network, corporate networks, or even home networks, or any of the types of networks mentioned above.

Data may be transmitted and received via Network 1420 utilizing a standard networking protocol or a standard telecommunications protocol.

While FIG. 14 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals. Interface 1442 may represent a user interface and/or other interactive communication portal.

System 1430 may be communicatively coupled to Database 1452 and may include any suitable data structure to maintain the information and allow access and retrieval of the information. For example, Database 1452 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Database 1452 may be any suitable storage device or devices. The storage may be local, remote, or a combination thereof with respect to Database 1452. Database 1452 may have back-up capability built-in. Communications with Database 1452 may be over a network, or communications may involve a direct connection between Database 1452 and System 1430, as depicted in FIG. 14.

Data quality processing may operate in different distinct modes depending on the state of the data being evaluated. A first mode, referred to as on-demand mode, applies data quality checks to data at rest that is stored in databases or other persistent storage systems. In on-demand mode, a user or automated system may trigger data quality evaluation at any desired time to assess the current quality state of stored datasets. A user or automated system may register an application with the data quality system and receive an authentication token. Using the token, the user or automated system may submit a request to trigger a data quality process on a specified dataset by providing parameters including platform name, database name, schema name, and dataset name. User may represent an automated system, AI agent, service and/or other entity or software component that interacts with an embodiment of the present invention. The system may execute applicable data quality rules against the dataset and return a job identifier that allows the user to track and retrieve results. The user may poll the system to receive status updates indicating whether the job is queued, running, failed, or successful. Other status information may be available. Upon completion, the system may provide detailed results including individual rule outcomes with failure counts and pass or fail determinations, as well as summary metrics showing total rules executed, passed, and failed. The on-demand capability allows users to define custom quality thresholds appropriate for their specific use cases and to compare results between multiple data quality runs on the same dataset.

A second mode, referred to as in-flight mode, applies data quality checks to data that is actively flowing through data pipelines during extraction, transformation, and loading operations. In in-flight mode, data quality checks may be performed while data is being transferred from source systems to target systems, allowing quality issues to be identified and addressed before the data reaches its destination. When data flows through extraction, transformation, and loading pipelines, data quality rules may be retrieved from a rules repository based on metadata associated with the pipeline. The rules may be applied to dataframes while the data remains in memory, identifying records that fail quality criteria. The system supports configurable actions for handling failed records, including dropping failed records while loading passed records, quarantining failed records in a separate table for review, loading all records with flags indicating quality failures, or failing the entire pipeline when quality thresholds are not met. In-flight checks may be applied at multiple stages within a pipeline, such as after reading source data and after applying transformations, providing guardrails that filter bad records before data reaches target destinations. The system captures data quality metrics including pass and fail counts for each rule, as well as pipeline metrics including execution status, duration, and record counts. A decorator pattern enables injection of data quality checks into existing pipelines without modifying core pipeline logic.

A data architecture may include multiple layers that organize data according to different stages of processing and quality standards. A raw data layer may store data in its original form as received from source systems without modification or quality enforcement. A standardized data layer may store data that has been normalized and formatted according to predefined standards, with baseline quality expectations applied. A curated data layer may store data that has undergone additional validation and enrichment, with higher quality thresholds than the standardized data layer. A tailored data layer may store data that has been prepared for specific analytical or business purposes, with quality requirements appropriate for the intended use case.

Each data layer in the architecture may have specific quality thresholds that define the minimum acceptable quality level for data to be admitted into that layer. When data moves from one layer to another through a data pipeline, in-flight checks may evaluate the data against the quality thresholds defined for the target layer. Data that meets the quality thresholds for a target layer may proceed into that layer, while data that fails to meet the thresholds may be filtered, quarantined, or otherwise handled according to configured actions. The quality thresholds for each layer may differ based on the purpose and consumers of data within that layer, with layers serving more sensitive or public-facing purposes potentially having more stringent quality requirements than layers serving exploratory or intermediate processing purposes.

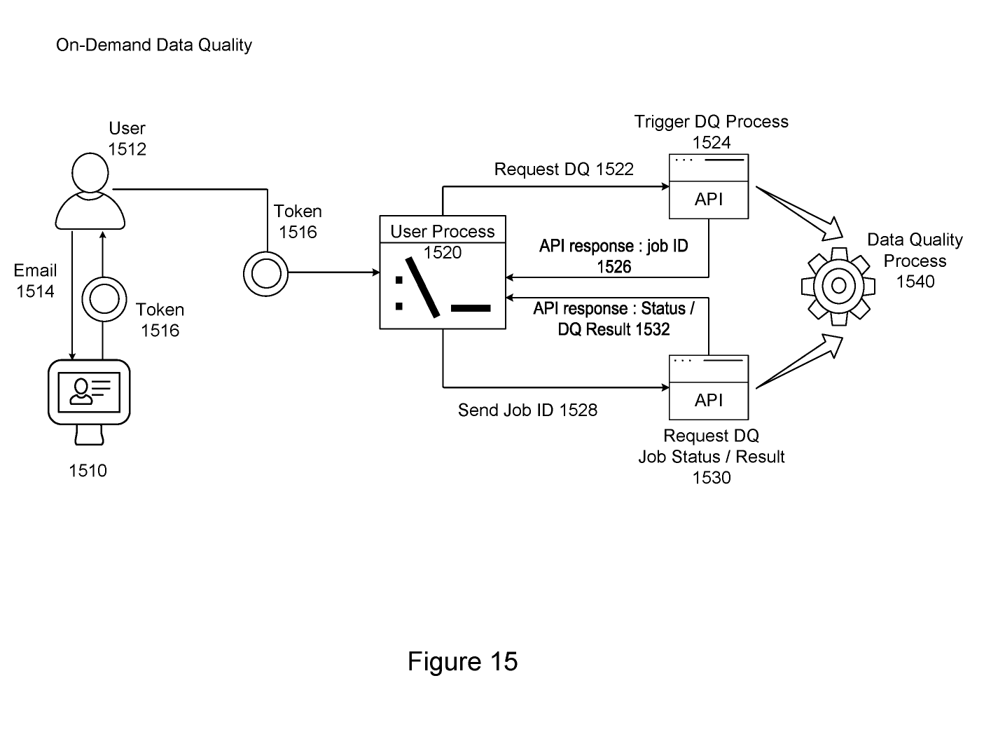

FIG. 15 is an exemplary system diagram for on-demand data quality processing, according to an embodiment of the present invention. As shown in FIG. 15, an on-demand data quality processing system may include a User Device 1510, a User Process 1520, and a Data Quality Process 1540. User Device 1510 may represent a computing device such as a desktop computer, laptop, server, or other networked device from which a user or automated system initiates data quality requests. User Device 1510 communicates with User Process 1520 through a Token 1516, which provides authentication and authorization for data quality operations.

To obtain Token 1516, a User 1512 may register an application with the data quality system by providing registration information including an application name, an application description, an application owner, and/or a database owner, via Email 1514 for example. Upon successful registration, the system generates and provides Token 1516 to the requestor. Token 1516 may be delivered to User Device 1510 via email or other communication channel. Token 1516 may then be used to validate data quality requests submitted by registered application users, ensuring that access to data quality services is restricted to authorized users and applications.

When a user initiates a data quality request, User Process 1520 sends a Request DQ 1522 to an application programming interface (API) that triggers Data Quality Process 1540, as shown by 1524. Request DQ 1522 may include parameters specifying the target dataset for quality evaluation, including platform name, database name, schema name, and/or dataset name. In response to Request DQ 1522, the API returns an API response job ID 1526 to User Process 1520. API response job ID 1526 may contain a unique identifier that distinguishes the particular data quality job instance from other job instances, allowing users to track and reference specific data quality processes.

User Process 1520 may subsequently send a Send Job ID 1528 request to another API endpoint to retrieve the status and results of the data quality process. Send Job ID 1528 request may include the job identifier received in the API response job ID 1526, allowing the system to locate and return information about the corresponding data quality job. The API, as shown by 1530, communicates with Data Quality Process 1540 to obtain the current job execution status and data quality results. The API then returns an API response status DQ result 1532 to User Process 1520, providing information about the current status of the job execution and the data quality results once processing is complete.

Data Quality Process 1540 performs data quality checks on the requested dataset. Data Quality Process 1540 may support various database platforms allowing users to request data quality evaluation for datasets stored and managed across different database technologies. Data Quality Process 1540 retrieves applicable data quality rules from a rules repository and evaluates the specified dataset against those rules. Upon completion of the evaluation, the Data Quality Process 1540 generates results that are made available through the API response status DQ result 1532. Data Quality Process 1540 may represent a metadata-driven data quality framework as described above.

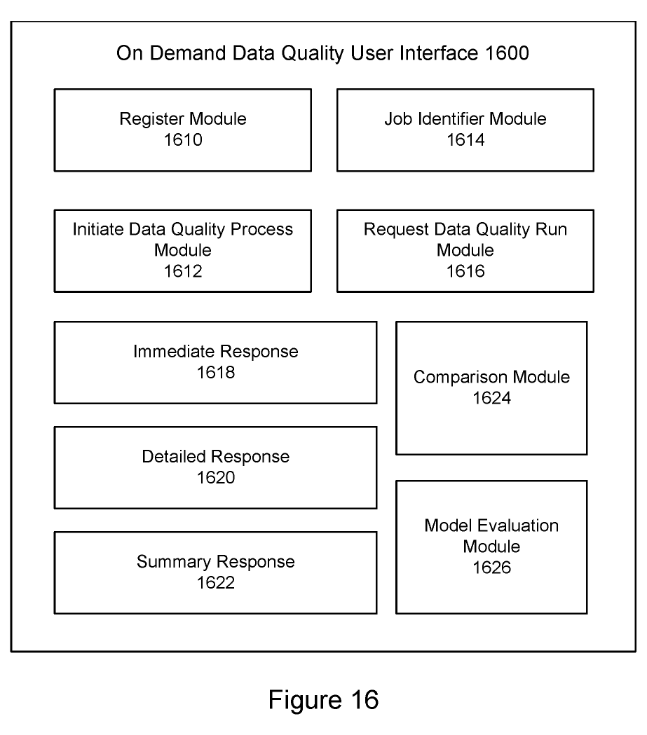

FIG. 16 illustrates an exemplary on-demand data quality user interface, according to an embodiment of the present invention. As shown in FIG. 16, an On Demand Data Quality User Interface 1600 includes a combination of modules, processors and components including a Register Module 1610, an Initiate Data Quality Process Module 1612, a Job Identifier Module 1614, a Request Data Quality Run Module 1616, an Immediate Response 1618, a Detailed Response 1620, and a Summary Response 1622. Other interactive tools may include Comparison Module 1624 and Model Evaluation Module 1626. Other functionality and processing may be provided. The processing components are exemplary and illustrative only. For example, Data Quality User Interface 1600 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

Register Module 1610 provides functionality for users to register their applications with the data quality system. Through Register Module 1610, users may submit registration information including an application name, an application description, an application owner, and/or a database owner. Upon successful registration through Register Module 1610, the system generates and provides a token to the requestor, enabling authentication and authorization for subsequent data quality operations.

Initiate Data Quality Process Module 1612 allows users to trigger a data quality process on a specified dataset. Through Initiate Data Quality Process Module 1612, users may specify target dataset parameters including platform name, database name, schema name, and/or dataset name. Initiate Data Quality Process Module 1612 may begin evaluation of the specified dataset against applicable data quality rules.

Job Identifier Module 1614 generates, stores and manages unique identifiers assigned to each data quality run instance. When a user initiates a data quality process through Initiate Data Quality Process Module 1612, the system generates a unique job identifier through Job Identifier Module 1614. Job Identifier Module 1614 allows users to track and reference specific data quality processes, enabling retrieval of status and results for particular job instances.

Request Data Quality Run Module 1616 enables users to submit requests for executing data quality checks against particular datasets. Through Request Data Quality Run Module 1616, users may define custom thresholds that differ from platform defaults for specific use cases. For example, a user creating an executive dashboard may define a threshold requiring data to be 95% good, even when the underlying data layer maintains a lower threshold such as 80%. The custom thresholds defined through Request Data Quality Run Module 1616 allow users to enforce quality standards appropriate for the intended consumption of the data.

An embodiment of the present invention may generate various types of responses and outputs represented by Immediate Response 1618, Detailed Response 1620 and Summary Response 1622.

Immediate Response 1618 provides an initial acknowledgment upon submission of a data quality request. Immediate Response 1618 may contain status information indicating the current job execution state. The job execution status returned in Immediate Response 1618 may indicate that the job is queued, running, failed, or success. Users may poll the system at periodic intervals to receive Immediate Response 1618 until the data quality process completes.

Detailed Response 1620 returns comprehensive results of the data quality run. Detailed Response 1620 includes individual rule results with information for each rule evaluated against the dataset. For each rule, Detailed Response 1620 may include a rule reference number, a column name, an assertion name, a criticality level, a failure count, a total rows count, and a pass or fail result. The rule reference number uniquely identifies the data quality rule that was evaluated. The column name indicates the data column to which the rule was applied. The assertion name describes the type of check performed, such as null analysis, string maximum length, or date range check. The criticality level indicates the severity classification of the rule, such as high or medium. The failure count indicates the number of records that failed the rule. The total rows count indicates the total number of records evaluated. The pass or fail result indicates whether the dataset met the threshold for the rule.

Summary Response 1622 provides an aggregated overview of the data quality results. Summary Response 1622 may include total rules ran, total rules passed, and total rules failed as aggregate metrics. Summary Response 1622 allows users to assess the overall quality state of a dataset without reviewing individual rule results.

On Demand Data Quality User Interface 1600 enables comparison of data quality results between multiple job runs on a single dataset, as shown by Comparison Module 1624. For example, a user may initiate a first data quality run, review the results, make improvements to the data, and then initiate a second data quality run. By comparing values and corresponding results between the two runs, the user may determine which run produced better quality data. The comparison functionality allows users to assess whether data corrections or improvements have resulted in measurable quality gains.

On Demand Data Quality User Interface 1600 may also evaluate data quality of outputs from multiple models as compared to a benchmark (e.g., prior baseline, learned expectations, etc.) as shown by Model Evaluation Module 1626. When multiple models generate data, a user may initiate separate data quality runs against the output of each model. By comparing the results across the multiple runs to a benchmark, the user may determine which model generated the best quality data. Model Evaluation Module 1626 allows users to select models based on objective data quality metrics, supporting automated decision-making within data pipelines regarding which model output to use for downstream processing.

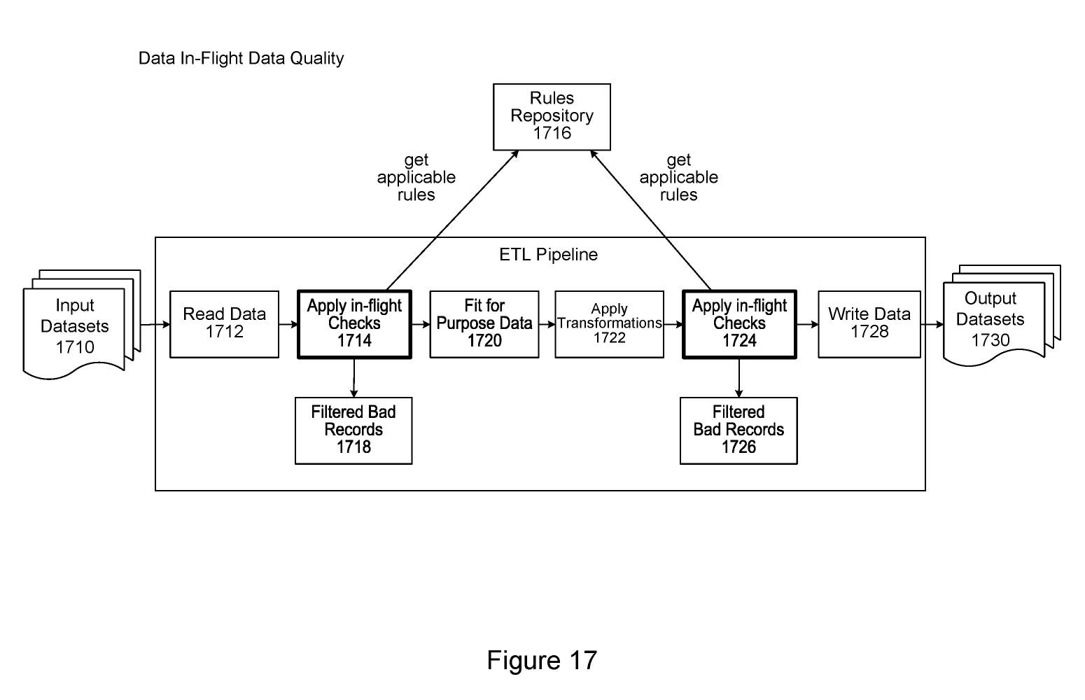

FIG. 17 is an exemplary illustration of a data in-flight data quality process, according to an embodiment of the present invention. As shown in FIG. 17, a data in-flight data quality process within an ETL (Extract, Transform, Load) pipeline may include Input Datasets 1710, Read Data 1712, Apply In-Flight Checks 1714, Rules Repository 1716, Filtered Bad Records 1718, Fit for Purpose Data 1720, Apply Transformations 1722, a second Apply In-Flight Checks 1724, Filtered Bad Records 1726, Write Data 1728, and Output Datasets 1730. The data in-flight data quality process applies data quality checks at multiple stages while data is actively flowing through the pipeline, allowing quality issues to be identified and addressed before data reaches a target destination.

Input Datasets 1710 may represent source data to be processed through the ETL pipeline. Input Datasets 1710 may include one or more datasets from various source systems, such as claims tables, policy tables, and/or other data sources relevant to the processing operation. Read Data 1712 reads data from Input Datasets 1710 into the pipeline for processing. During Read Data 1712, data from the Input Datasets 1710 may be loaded into an in-memory data structure such as a dataframe, e.g., Spark dataframe, allowing subsequent processing operations to be performed on the data while the data remains in-flight.

Apply In-Flight Checks 1714 applies data quality checks to the data while the data is in-flight. Apply In-Flight Checks 1714 may retrieve applicable rules from Rules Repository 1716, which stores data quality rules and associated metadata. Rules Repository 1716 may contain rules that specify quality criteria such as null analysis, string length validation, date range checks, referential integrity checks, and/or other validation logic. The rules stored in Rules Repository 1716 may include metadata that identifies which rules are applicable for in-flight execution and what actions should be performed when records fail the data quality checks.

Apply In-Flight Checks 1714 may evaluate records against the retrieved rules to determine which records meet the quality criteria and which records fail. Records that fail the data quality checks at Apply In-Flight Checks 1714 may be directed to Filtered Bad Records 1718, which captures records that do not meet the quality criteria. Filtered Bad Records 1718 may be stored for further review, analysis, and/or remediation. Records that pass the data quality checks at Apply In-Flight Checks 1714 proceed to Fit for Purpose Data 1720, representing data that meets baseline quality requirements established for the source data.

Apply In-Flight Checks 1714 applies data quality checks on source data to ensure that baseline quality expected from the source is met. By filtering records that fail quality checks before further processing, Apply In-Flight Checks 1714 ensures that Fit for Purpose Data 1720 contains data that is suitable for the intended processing operations. The filtering performed at Apply In-Flight Checks 1714 prevents bad data from propagating through the pipeline and affecting downstream systems.

As shown in FIG. 17, Fit for Purpose Data 1720 proceeds to Apply Transformations 1722, where the data may undergo various transformations as required by the pipeline. For example, Apply Transformations 1722 may perform operations such as data type conversions, field mappings, aggregations, joins between multiple datasets, calculations, and other transformation logic. The transformations applied at Apply Transformations 1722 prepare the data for loading into the target destination.

Apply In-Flight Checks 1724 may apply another set of data quality checks to the transformed data. Apply In-Flight Checks step 1724 may also retrieve applicable rules from Rules Repository 1716. The rules applied at Apply In-Flight Checks 1724 may differ from the rules applied at Apply In-Flight Checks 1714, as the second set of checks may validate quality criteria specific to the transformed data or the target destination requirements. In other instances, the rules may be the same, similar or related.

Apply In-Flight Checks 1724 may act as guardrails before data is loaded to the target. Records that fail the data quality checks at Apply In-Flight Checks 1724 may be directed to Filtered Bad Records 1726. Records that pass the data quality checks at Apply In-Flight Checks 1724 proceed to Write Data 1728, where the validated data may be written to the target destination. Write Data 1728 may store the validated data in Output Datasets 1730, which represent the final processed and validated data.

The application of multiple in-flight checks at Apply In-Flight Checks 1714 and Apply In-Flight Checks 1724 provides multiple validation points within the ETL pipeline. The first Apply In-Flight Checks 1714 ensures that source data meets baseline quality expectations before transformations are applied. The second Apply In-Flight Checks 1724 ensures that transformed data meets quality requirements before being loaded to the target. According to an embodiment of the present invention, the second Apply In-Flight Checks 1724 may apply additional expectations and guardrails to ensure that outcomes generated through AI-assisted processing are correct and trustworthy. The combination of source data checks and pre-load guardrails ensures that data quality is maintained throughout the data movement process, with Filtered Bad Records 1718 and Filtered Bad Records 1726 capturing records that fail quality checks at different stages of the pipeline.

Additional in-flight checks, filtering and/or transformations may be applied as needed or desired by various applications, systems and target destinations.

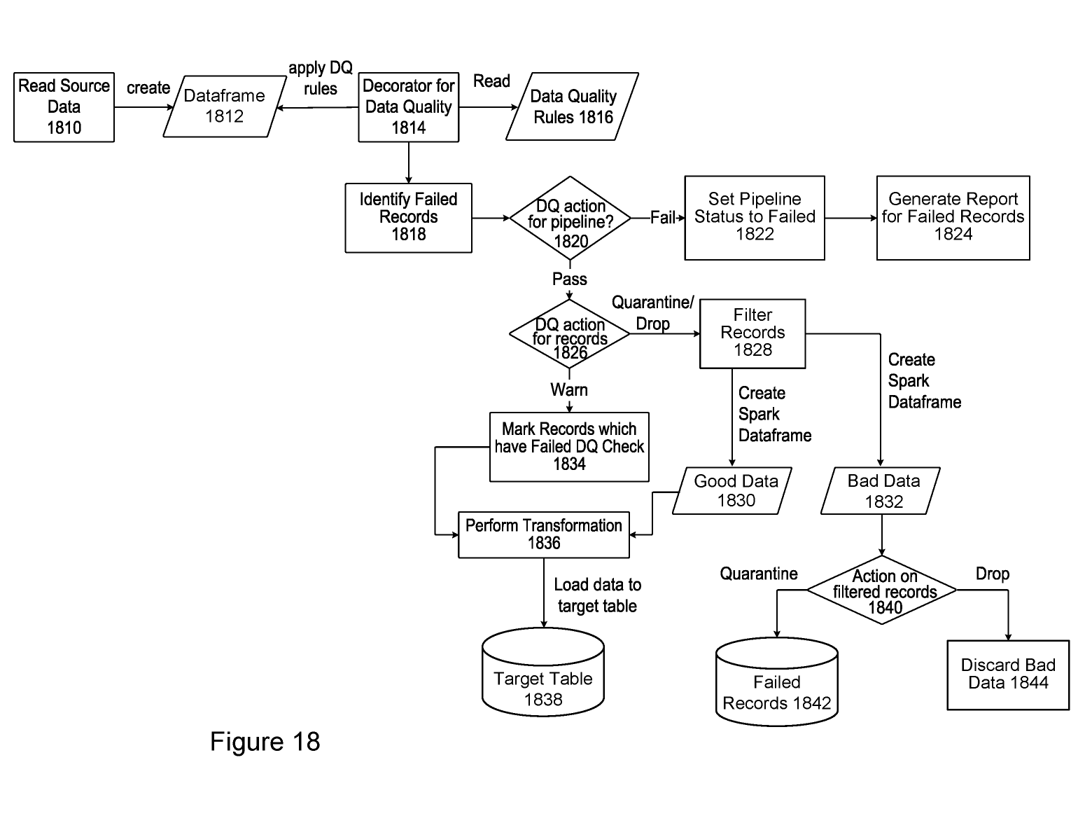

FIG. 18 is an exemplary flowchart for a data quality in-flight process, according to an embodiment of the present invention. As shown in FIG. 18, the flowchart illustrates a data quality in-flight process that applies data quality checks while data flows through a pipeline.

At step 1810, source data may be read from one or more source datasets. The source data may originate from various data sources such as databases, files, or streaming systems.

At step 1812, a dataframe may be created from the source data. The dataframe may be a Spark dataframe that holds the source data in memory, allowing subsequent processing operations to be performed on the data while the data remains in-flight through the pipeline. Other formats may be implemented.

At a step 1814, a decorator for data quality may be applied that reads data quality rules. The decorator or annotation pattern in code may inject in-flight data quality checks into existing data pipelines without modifying the core pipeline logic. For example, a PySpark decorator may be used to identify and execute rules on the dataframe while data remains in memory.

At step 1816, the decorator may retrieve applicable rules from a Rules Repository and apply those rules to evaluate records in the dataframe. The decorator pattern allows data quality checks to be added to a pipeline by including a simple annotation in the code, enabling developers to inject quality validation at desired points in the pipeline without restructuring the underlying data processing logic.

At step 1818, failed records may be identified based on the data quality rules. Step 1818 evaluates each record in the dataframe against the retrieved rules and flags records that do not meet the quality criteria specified by the rules. The identification of failed records at step 1818 may produce information about which records passed and which records failed the data quality checks.

At step 1820, data quality action may be determined for the pipeline. Step 1820 may evaluate the results of the data quality checks and determine whether the pipeline should proceed or fail based on the configured action and thresholds. If the data quality results indicate that the pipeline should fail, the process proceeds to step 1822, where the pipeline status is set to failed. At step 1824, a report may be generated for the failed records. The report provides information about the records that failed data quality checks, enabling users to review and address the quality issues.

If the data quality action at step 1820 results in a pass determination, step 1826 determines a specific data quality action for the records. If the action is quarantine or drop, the process moves to step 1828, where records are filtered. The filtering separates records based on whether the records passed or failed the data quality checks. The process proceeds to step 1832, which creates a dataframe, e.g., Spark dataframe, that separates good data 1830 from bad data 1832.

For records identified as bad data at step 1832, the process proceeds to an action decision point at step 1840. If the configured action is quarantine, the failed records are stored in a separate quarantine table or storage location as shown by 1842, preserving the records for later review and potential remediation by users. If the configured action is drop, the bad data may be discarded. This may involve removing the failed records from the pipeline without storing the records as shown by 1844, allowing the pipeline to proceed with only the passing records.

If the data quality action is warn, the process moves to a step 1834, where records that have failed the data quality check are marked. Step 1834 may add flags or indicators to the failed records to identify the records as having quality issues, while retaining the records in the data flow. The marking performed at step 1834 allows downstream consumers to identify which records have quality concerns while still providing access to all records.

The good data from step 1830 and the marked records from step 1834 may proceed to step 1836, where transformation may be performed. Step 1836 may apply transformation logic to prepare the data for loading into the target destination. Following the transformation at the step 1836, the data may be loaded to a target table as shown by 1838. The process completes the data movement from source to target with data quality checks applied during the in-flight processing.

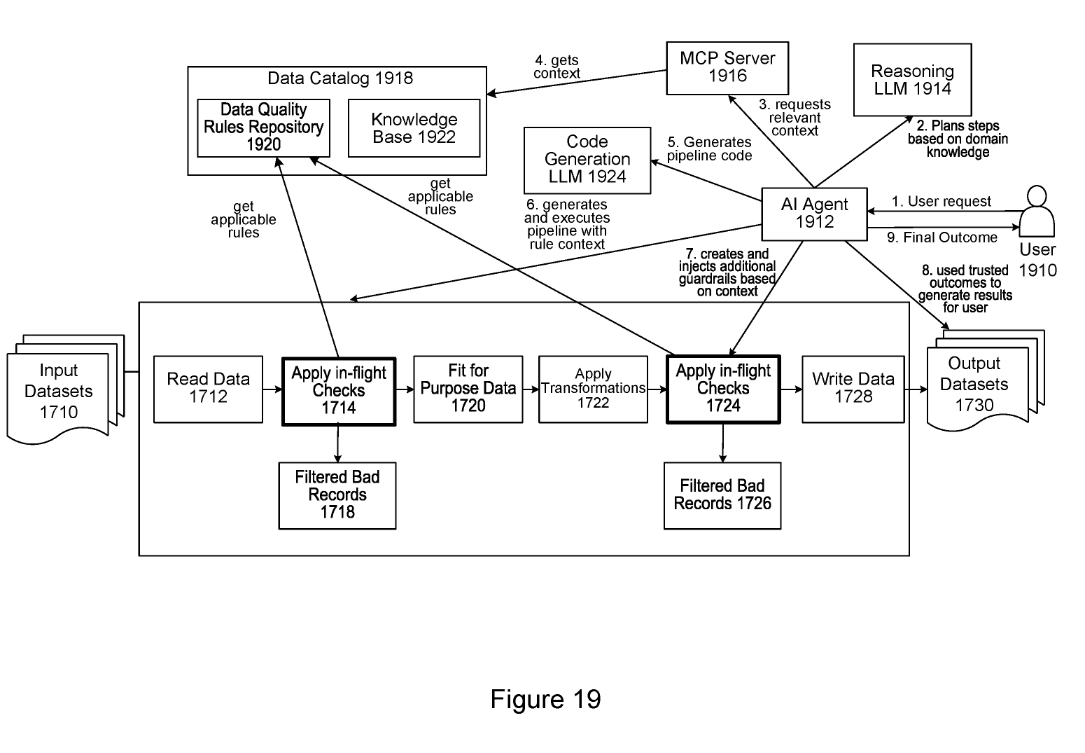

FIG. 19 is an exemplary illustration of a data in-flight data quality process, according to an embodiment of the present invention. FIG. 19 builds on the illustration shown in FIG. 17. An embodiment of the present invention is directed to an AI-powered data quality system that integrates metadata-driven data quality checks with artificial intelligence components to generate and execute data quality checks on data in-flight. The AI-powered data quality system may receive requests from a User 1910 and/or from an AI Agent 1912. User 1910 may be a human user who submits data insight requests to the system. AI Agent 1912 may be an automated software agent that receives requests from User 1910 or from another AI agent or system and orchestrates the execution of data quality processes.

AI Agent 1912 interacts with Reasoning LLM 1914 that may be finetuned on a particular business domain, such as insurance, to determine steps needed to complete data insight requests. When AI Agent 1912 receives a data insight request, AI Agent 1912 communicates with Reasoning LLM 1914 to determine the steps needed to fulfill the request. Reasoning LLM 1914 may represent a large language model trained or fine-tuned on domain-specific knowledge, such as insurance industry terminology, data structures, and/or business rules. Reasoning LLM 1914 analyzes the data insight request and generates a set of steps that AI Agent 1912 should execute to produce the requested insight.

AI Agent 1912 interacts with MCP Server 1916 to pull relevant context based on metadata for task execution. MCP Server 1916 provides access to Data Catalog 1918 that includes Data Quality Rules Repository 1920 and Knowledge Base 1922. Data Quality Rules Repository 1920 may store data quality rules that may be applied to datasets during processing. Knowledge Base 1922 may contain metadata about datasets, data elements, and/or data relationships within the data platform. Knowledge Base 1922 may store and manage glossary information, data dictionary entries, data lineage information, and knowledge base content that describes the available data assets. Accordingly, AI Agent 1912 may have context of Knowledge Base 1922 as well as Data Quality Rules Repository 1920 while building the pipeline and may therefore select which existing data quality rules to run as in-flight checks apart from additional contextual data quality checks.

AI Agent 1912 may query MCP Server 1916 to retrieve metadata from Data Catalog 1918 that is relevant to the set of steps identified by Reasoning LLM 1914. AI Agent 1912 may assemble the metadata for the various steps in the task, creating a context that includes information about the source datasets, target datasets, applicable data quality rules from Data Quality Rules Repository 1920, and other relevant metadata. The assembled metadata context provides AI Agent 1912 with the information needed to generate a data pipeline that fulfills the data insight request.

AI Agent 1912 may interact with Code Generation LLM 1924 to generate pipeline code with the assembled metadata context. Code Generation LLM 1924 may be a large language model that has been trained to generate executable code for data processing pipelines. AI Agent 1912 provides Code Generation LLM 1924 with the assembled metadata context, including information about source datasets, target datasets, transformations to be applied, and data quality rules to be enforced. Code Generation LLM 1924 generates pipeline code that implements the data processing logic needed to fulfill the data insight request.

The generated pipeline code processes data through a series of steps. Input Datasets 1710 represent source data to be processed, which may include datasets identified through the metadata context assembled from Data Catalog 1918. Read Data 1712 reads data from Input Datasets 1710 into the pipeline. Following Read Data 1712, Apply In-Flight Checks 1714 seeks to run a standard set of data quality rules from Data Quality Rules Repository 1920 which may be distinct from checks defined by AI Agent 1912. AI Agent 1912 may then read Data Catalog 1918 to retrieve and/or ascertain existing checks for source datasets and then determine which existing checks to include and/or generate new data quality checks to introduce from context gathered thus far while building the pipeline.

Records that fail the data quality checks at Apply In-Flight Checks 1714 are directed to Filtered Bad Records 1718. Records that pass the data quality checks proceed to Fit for Purpose Data 1720, representing data that meets baseline quality requirements. Fit for Purpose Data 1720 then undergoes Apply Transformations 1722, which applies transformation logic as specified in the generated pipeline code.

AI Agent 1912 generates additional expectations and guardrails that may be applied through Apply In-Flight Checks 1724. AI Agent 1912 leverages context from Data Catalog 1918 and Data Quality Rules Repository 1920 to generate additional validation rules that may be applied to the output of the generated code. The additional expectations and guardrails applied at Apply In-Flight Checks 1724 ensure that outcomes produced by the AI-generated pipeline are correct and trustworthy. Records that fail the data quality checks at Apply In-Flight Checks 1724 are directed to Filtered Bad Records 1726. Records that pass the data quality checks proceed to Write Data 1728, which stores the validated data in Output Datasets 1730.

AI Agent 1912 executes the generated pipeline and makes the passing validated outcome available to User 1910 or to another AI agent. By injecting in-flight data quality checks after reading data from source datasets and by generating additional expectations and guardrails applied to outputs, AI Agent 1912 ensures that data insights produced through AI-generated pipelines meet quality standards and may be trusted for decision-making purposes.

Additional in-flight checks, filtering and/or transformations may be applied as needed or desired by various applications, systems and target destinations.

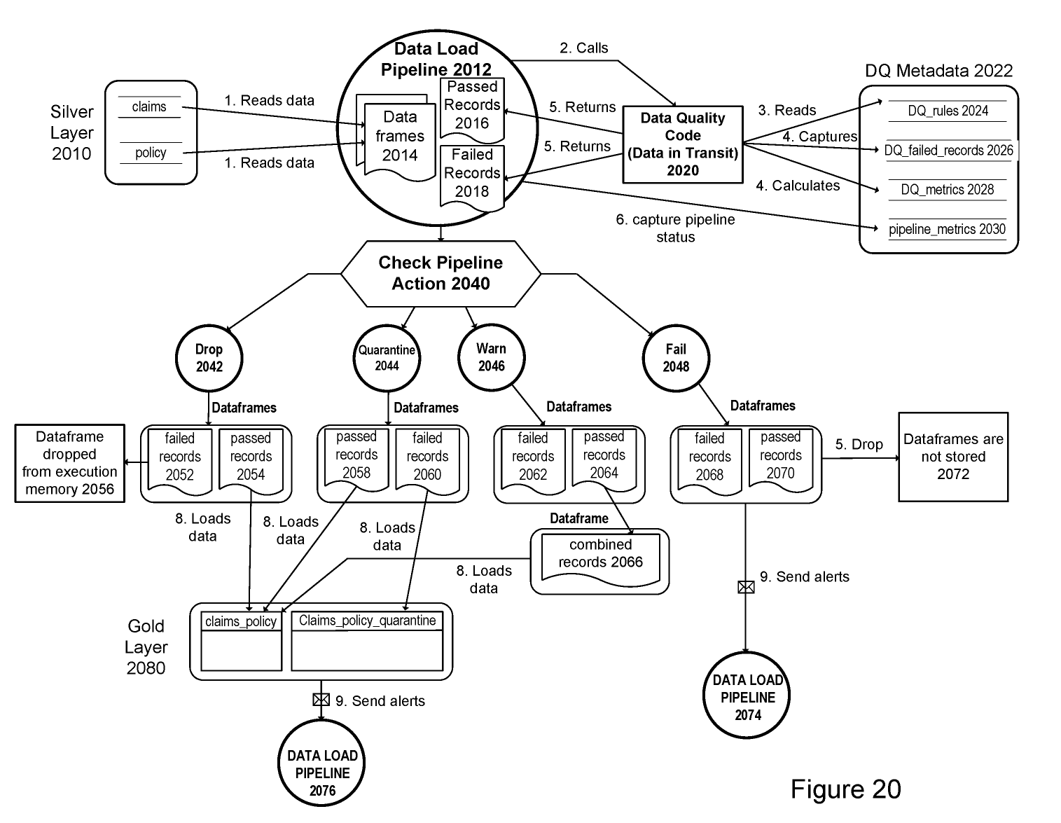

FIG. 20 is an exemplary system diagram of a data quality in-flight with configurable actions, according to an embodiment of the present invention. As shown in FIG. 20, a data quality in-flight system with configurable actions includes Silver Layer 2010, Data Load Pipeline 2012, Data Quality Code 2020, DQ Metadata 2022, Check Pipeline Action 2040 and Gold Layer 2080. Silver Layer 2010 contains source datasets such as claims tables and policy tables that serve as input data for the data quality in-flight system. Silver Layer 2010 may correspond to a standardized data layer within a multi-layer data architecture where data has been normalized and formatted according to predefined standards.

According to an exemplary illustration of real-time data quality enforcement in a data pipeline, a scenario may involve claims and policy data. In this example, a data quality rule may specify that “Policy number for a Claim cannot be blank.” Claims and Policy source tables may be joined to produce a dataframe containing fields such as claim_number and policy_number.

According to an embodiment of the present invention, the data quality process may apply the rule to the dataframe. This may involve splitting data into two sets: records that pass the check (policy number present) and records that fail (policy number missing). The system may then route these records according to configurable pipeline actions. For example, failed records may be quarantined to a separate table for further analysis, dropped from loading, flagged with warnings, or cause the pipeline to fail entirely, depending on the business requirement.

For Quarantine, failed records are written to a quarantine table (claims_policy_quarantine), while passed records are loaded to the main target table (claims_policy). The pipeline succeeds and alerts are sent. For Fail, no records are loaded if failures occur; alerts are sent and the pipeline fails. For Drop, only passing records are loaded while failed records are dropped. The pipeline succeeds and alerts are sent. For Warn: all records are loaded, with failed ones flagged. The pipeline succeeds and alerts are sent.

This process ensures that only validated records are loaded into the target table (or downstream systems), while failed records are tracked and managed according to the defined data quality action. Metrics relating to failures may be captured for reporting and monitoring, supporting continuous data quality improvement in a scalable, automated fashion within the pipeline.

As shown in FIG. 20, the Data Load Pipeline 2012 reads data from Silver Layer 2010 and organizes the data into Dataframes 2014. Dataframes 2014 may be in-memory data structures such as Spark dataframes that hold the source data while the data is in transit through the pipeline. Data Load Pipeline 2012 processes Dataframes 2014 and separates records into Passed Records 2016 and Failed Records 2018 based on data quality evaluation performed by Data Quality Code 2020.

Data Quality Code 2020 operates on data in transit within Data Load Pipeline 2012. Data Quality Code 2020 reads from DQ Metadata 2022, which stores DQ Rules 2024 that define the quality checks to be applied to the data. DQ Metadata 2022 contains metadata that identifies which rules may be executed while data is in-flight and specifies the action to be performed when records fail data quality checks. DQ Rules 2024 may include validation logic such as null analysis, string length validation, date range checks, and referential integrity checks.

Data Quality Code 2020 evaluates records in Dataframes 2014 against DQ Rules 2024 and identifies records that fail the quality criteria. DQ Failed Records 2026 are captured by the Data Quality Code 2020 for further analysis and reporting. Data Quality Code 2020 calculates DQ Metrics 2028 based on the evaluation results. DQ Metrics 2028 may represent summarizations showing the number of passes and failures for each rule applied to a dataset.

Pipeline Metrics 2030 may capture information about the execution of Data Load Pipeline 2012. For example, Pipeline Metrics 2030 may capture pipeline state, success or failure status, execution duration, and number of records processed. The pipeline state may indicate whether the pipeline is currently running, has completed successfully, or has failed. The execution duration indicates how long the pipeline took to process the data. The number of records processed indicates the volume of data that flowed through the pipeline.

In addition, Pipeline Metrics 2030 may be used to calculate and predict the computational cost of running data quality tests on datasets of varying sizes. By analyzing Pipeline Metrics 2030 over multiple pipeline executions, the system may determine relationships between dataset size, rule complexity, and computational resources consumed. The cost prediction functionality allows users or automated system to estimate the resources required to perform data quality checks on large datasets before initiating the checks. In addition, an embodiment of the present invention enables users to determine whether a full dataset check is required or whether a subset is sufficient. Resources may be allocated based on the volume of data and/or complexity of the data quality check.

An embodiment of the present invention may support sampling strategies where a percentage sample of data may be tested instead of the full dataset based on cost and resource considerations. When a dataset contains a large number of records, testing the entire dataset may consume substantial computational resources in a cloud environment. Pipeline Metrics 2030 enable the system to compare the cost of testing the full dataset against the cost of testing a sample, such as a five percent sample. Based on the cost comparison and the acceptable quality tolerance for the use case, users or automated systems may select a sampling strategy that balances quality assurance with resource efficiency. The sampling strategy selection may consider the type of data, the application for which the data is being used, and the size of the dataset to determine an appropriate balance between comprehensive testing and resource consumption.

Check Pipeline Action 2040 determines how records are handled based on the results of data quality evaluation performed by Data Quality Code 2020. Check Pipeline Action 2040 receives Passed Records 2016 and Failed Records 2018 from Data Load Pipeline 2012 and routes the records according to a configured action type. As shown in FIG. 20, Check Pipeline Action 2040 supports four distinct configurable actions: a Drop action 2042, a Quarantine action 2044, a Warn action 2046, and a Fail action 2048. Check Pipeline Action 2040 may also include additional options, such as a no action option when all records pass data quality checks at one hundred percent accuracy, in which case all records proceed to the target without any filtering, quarantining, or failure handling.

The thresholds for triggering the Drop action 2042, the Quarantine action 2044, the Warn action 2046, and the Fail action 2048 may be configurable at the rule level and the pipeline level. At the rule level, a threshold may be defined for a specific data quality rule, such that the rule triggers a particular action when the percentage of passing records falls below the threshold. At the pipeline level, a threshold may be defined that applies across all rules evaluated within the pipeline. For example, a pipeline may be configured such that if data quality is only fifty percent good, the Fail action 2048 is triggered because the quality is considered too low for the intended use case. For a different rule and pipeline combination, the Quarantine action 2044 may be set at eighty-five percent, while for another combination, the threshold may be ninety percent. The configurable thresholds provide the ability to define quality standards appropriate for the purpose of each pipeline and the use case for which the data will be consumed.

When the Drop action 2042 is selected, the Check Pipeline Action 2040 processes dataframes containing Failed Records 2052 and Passed Records 2054. Failed Records 2052 result in a Dropped Dataframe 2056 that is removed from execution memory without being stored. Drop action 2042 discards the failed records without preserving the records for later review or remediation. Passed Records 2054 are loaded to a target table in Gold Layer 2080. Drop action 2042 loads only passing records to the target table without storing failed records while allowing Data Load Pipeline 2012 to succeed. Drop action 2042 may be appropriate for scenarios where a user has a large volume of records and is willing to lose a percentage of records that fail quality checks, such as when a large number of records is available and losing twenty percent still leaves a number of records sufficient for the intended analysis.

When the Quarantine action 2044 is selected, Check Pipeline Action 2040 separates Passed Records 2058 and Failed Records 2060 into different dataframes. Passed Records 2058 are loaded to a claims policy table in Gold Layer 2080, while Failed Records 2060 are stored in a separate claims policy quarantine table. Quarantine action 2044 stores failed records in a separate table for review and fixes while loading passing records to the target table. The quarantine table preserves the failed records so that a human user or automated system may review the records, identify the quality issues, and apply corrections. After corrections are made to the quarantined records, Data Load Pipeline 2012 may be restarted to process the corrected records. The Quarantine action 2044 allows the Data Load Pipeline 2012 to succeed while ensuring that records with quality issues are not loaded into the target table where the records could affect downstream analytics or reporting.

When the Warn action 2046 is selected, Check Pipeline Action 2040 creates dataframes containing Failed Records 2062 and Passed Records 2064. Failed Records 2062 and Passed Records 2064 are combined into Combined Records 2066. The Warn action 2046 loads all records to the target table with a flag indicating which records have data quality failures while allowing Data Load Pipeline 2012 to succeed. The flag added to records in Combined Records 2066 identifies which records passed and which records failed the data quality checks. Downstream consumers of the data in Gold Layer 2080 may use the flag to filter or handle records with quality issues according to their own requirements. The system may send email alerts or other notifications to notify users that records with quality failures have been loaded to the target table. The Warn action 2046 may be appropriate for scenarios where the data quality is close to the acceptable threshold, such as when data is ninety-seven percent good and the threshold is ninety-eight percent, and a warning is sufficient to alert users while still providing access to all records.

When the Fail action 2048 is selected, Check Pipeline Action 2040 identifies Failed Records 2068 and Passed Records 2070. The Fail action 2048 prevents any data from being loaded to the target table and causes the entire Data Load Pipeline 2012 to fail if even one data quality check fails. Failed Records 2068 and Passed Records 2070 result in Dataframes that are not stored, as shown by 2072 where no data is loaded to Gold Layer 2080. The system may send email alerts or other notifications and trigger a data load pipeline notification to inform users that the pipeline has failed due to data quality issues. The Fail action 2048 may be appropriate for scenarios where data quality requirements are strict and loading any data with quality issues would be unacceptable for the intended use case.

According to an embodiment of the present invention, the data quality in-flight system sends notifications to users responsible for data when records fail data quality checks. When the Quarantine action 2044 is selected and the Failed Records 2060 are stored in the quarantine table, the system identifies the user or users responsible for the source data and sends notifications to those users. The notifications inform the responsible users that records have failed data quality checks and have been quarantined for review. The notifications may include information about which rules failed, the number of records affected, and the location of the quarantined records. The responsible users may then access the quarantine table, review Failed Records 2060, identify the quality issues, and/or apply corrections to remediate the data quality problems.

After corrections may be applied to the quarantined records, a Data Load Pipeline 2074 may be initiated to process the corrected records. Data Load Pipeline 2074 reads the corrected records from the quarantine table and applies the same data quality checks that were applied during the original processing. If the corrected records pass the data quality checks, Data Load Pipeline 2074 loads the corrected records to Gold Layer 2080. A Data Load Pipeline 2076 may also be initiated to reprocess source data after corrections have been made at the source. Data Load Pipeline 2076 reads the corrected source data from Silver Layer 2010 and processes the data through the same data quality evaluation and action handling as the original Data Load Pipeline 2012.

An embodiment of the present invention may track which rule for which pipeline failed when records are quarantined or otherwise flagged for quality issues. For each failure, the system records the pipeline identifier, the rule identifier from DQ Rules 2024, and the purpose for which the data is being processed. When a user applies a correction to remediate a failed record, the system records the remedy that was applied to correct the record. The combination of pipeline identifier, rule identifier, purpose, and applied remedy creates a correction record that captures the relationship between the failure pattern and the successful remediation approach.

Over time, the system accumulates correction records from multiple instances where users have manually corrected failed records. The system analyzes the accumulated correction records to learn correction behaviors that may be applied automatically in future processing. An embodiment of the present invention may apply learned corrections automatically in real time when the same or similar combination of purpose, rule, and/or failure pattern occurs during subsequent data processing. When Data Quality Code 2020 identifies a record that fails a rule, the system may check whether a learned correction exists for the combination of the current pipeline purpose, the failed rule from DQ Rules 2024, and the failure pattern exhibited by the record. If a learned correction exists and meets confidence thresholds, the system may automatically apply the correction to the record without requiring manual intervention. The automatic correction capability reduces the need for human review of records that exhibit failure patterns for which reliable corrections have been learned from past remediation activities.

DQ Rules 2024 stored in DQ Metadata 2022 may include rules that check whether sensitive data has been properly masked before reaching target layers. Data elements may be classified through a data classification process that identifies data as personally identifiable information (PII), protected health information (PHI), or other sensitivity categories. When data elements are classified as PII or PHI, the data elements are tagged with the appropriate sensitivity classification. DQ Rules 2024 may include validation rules that check whether data elements tagged as PII or PHI have been masked according to masking requirements before the data is loaded to the Gold Layer 2080.

When data moves from Silver Layer 2010 toward Gold Layer 2080, Data Quality Code 2020 may apply rules from DQ Rules 2024 that verify masking compliance for sensitive data. A masking compliance rule may check whether a data element classified as PII or PHI contains masked values rather than clear text values. If the masking compliance rule determines that a sensitive data element has not been properly masked, the record containing the unmasked sensitive data is identified as a failed record. The failed record may then be handled according to the configured action, such as the Quarantine action 2044 or the Fail action 2048, to prevent unmasked sensitive data from being loaded to the target layer where the data would be visible to users who should not have access to the unmasked values. The application of masking compliance rules during in-flight processing ensures that sensitive data is protected before reaching layers where the data may be consumed for analytics or reporting purposes. Other variations may be applied.

The data quality processing systems and methods described herein are directed to specific technical improvements in data pipeline processing. The in-flight data quality checks operate on dataframes within memory during pipeline execution, applying rules retrieved from a rules repository to filter, quarantine, or flag records before the records reach target storage systems. This technical approach prevents propagation of bad data through computing systems and reduces computational resources that would otherwise be consumed by reprocessing data after quality issues are discovered in target systems. The decorator pattern that injects data quality checks into pipeline code without modifying core pipeline logic represents a specific technical implementation that improves the functioning of data processing systems. The automatic learning of correction behaviors from accumulated correction records and the real-time application of learned corrections to subsequent failed records provide a technical solution that reduces manual intervention in data remediation workflows. The on-demand data quality assessment system provides a specific technical architecture including registration components, application programming interfaces, job identifiers, and response components that enable programmatic evaluation of data quality for datasets stored across multiple database platforms. These technical features are rooted in computer technology and provide improvements to the technical field of data quality management in data processing pipelines.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system for data quality assessment in a data pipeline, comprising:
an input configured to interface with one or more data sources through an extract, transform and load (ETL) pipeline; and
a computer processor coupled to the input and configured to perform the steps of:
reading source data from one or more input datasets into a dataframe within a data pipeline;
retrieving, from a rules repository, one or more data quality rules applicable to the dataframe based on metadata associated with the data pipeline;
applying the one or more data quality rules to the dataframe while the source data is in-flight within the data pipeline;
determining whether one or more records within the dataframe fail at least one of the one or more data quality rules as failed records;
determining a pipeline action based on metadata associated with the one or more data quality rules;
executing the pipeline action on the failed records, wherein the pipeline action is selected from one of: a drop action, a quarantine action, a warn action, and a fail action; and
applying one or more transformations to passed records that pass the one or more data quality rules to produce transformed records.

2. The system of claim 1, wherein the drop action causes the failed records to be discarded from execution memory without being stored and causes passed records to be loaded to a target table.

3. The system of claim 1, wherein the quarantine action causes the failed records to be stored in a quarantine table separate from a target table and causes passed records to be loaded to the target table.

4. The system of claim 3, wherein the computer processor is further configured to perform the step of:
sending a notification to a recipient responsible for the source data indicating that records have been quarantined for review.

5. The system of claim 1, wherein the warn action causes all records including the failed records and passed records to be loaded to a target table with a flag indicating which records have data quality failures.

6. The system of claim 1, wherein the fail action causes no data to be loaded to a target table and causes the data pipeline to be set to a failed status.

7. The system of claim 1, wherein the computer processor is further configured to perform the step of:
capturing one or more data quality metrics comprising a count of passed records and a count of failed records for each of the one or more data quality rules.

8. The system of claim 1, wherein the computer processor is further configured to perform the step of:
capturing pipeline metrics comprising pipeline execution status, execution duration, and a number of records processed.

9. The system of claim 1, wherein the computer processor is further configured to perform the step of:
applying a second set of data quality rules to the transformed records before writing the transformed records to a target destination.

10. The system of claim 1, wherein the metadata associated with the one or more data quality rules includes one or more threshold values that determine when the pipeline action is executed wherein the one or more threshold values are configurable at a rule level and at a pipeline level.

11. A method for data quality assessment in a data pipeline, comprising the steps of:
reading source data from one or more input datasets into a dataframe within a data pipeline;
retrieving, from a rules repository, one or more data quality rules applicable to the dataframe based on metadata associated with the data pipeline;
applying the one or more data quality rules to the dataframe while the source data is in-flight within the data pipeline;
determining whether one or more records within the dataframe fail at least one of the one or more data quality rules as failed records;
determining a pipeline action based on metadata associated with the one or more data quality rules;
executing the pipeline action on the failed records, wherein the pipeline action is selected from one of: a drop action, a quarantine action, a warn action, and a fail action; and
applying one or more transformations to passed records that pass the one or more data quality rules to produce transformed records.

12. The method of claim 11, wherein the drop action causes the failed records to be discarded from execution memory without being stored and causes passed records to be loaded to a target table.

13. The method of claim 11, wherein the quarantine action causes the failed records to be stored in a quarantine table separate from a target table and causes passed records to be loaded to the target table.

14. The method of claim 13, further comprising the step of:
sending a notification to a recipient responsible for the source data indicating that records have been quarantined for review.

15. The method of claim 11, wherein the warn action causes all records including the failed records and passed records to be loaded to a target table with a flag indicating which records have data quality failures.

16. The method of claim 11, wherein the fail action causes no data to be loaded to a target table and causes the data pipeline to be set to a failed status.

17. The method of claim 11, further comprising the step of:
capturing one or more data quality metrics comprising a count of passed records and a count of failed records for each of the one or more data quality rules.

18. The method of claim 11, further comprising the step of:
capturing pipeline metrics comprising pipeline execution status, execution duration, and a number of records processed.

19. The method of claim 11, further comprising the step of:
applying a second set of data quality rules to the transformed records before writing the transformed records to a target destination.

20. The method of claim 11, wherein the metadata associated with the one or more data quality rules includes one or more threshold values that determine when the pipeline action is executed wherein the one or more threshold values are configurable at a rule level and at a pipeline level.
